(19) United States
(12) Patent Application Publication
(10) Pub. No.: US 2025/0082144 A1
(43) Pub. Date: Mar. 13, 2025

(54) ROBOT CLEANER STATION

(71) Applicant: LG ELECTRONICS INC., Seoul (KR)

(72) Inventors: Sungjun KIM, Seoul (KR); Jinhyouk SHIN, Seoul (KR); Seungwoo HAN, Seoul (KR); Hwarang LEE, Seoul (KR); Chunghoon CHOI, Seoul (KR)

(73) Assignee: LG ELECTRONICS INC., Seoul (KR)

(21) Appl. No.: 18/828,284

(22) Filed: Sep. 9, 2024

(30) Foreign Application Priority Data
Sep. 8, 2023 (KR) 10-2023-0119850
Feb. 2, 2024 (KR) 10-2024-0016867

(51) Int. Cl. A47L 9/00; A47B 77/08; A47B 88/919; A47L 9/14; B08B 3/08; E03C 1/12

(52) U.S. Cl. CPC A47L 9/0063; A47B 77/08; A47B 88/919; A47L 9/149; B08B 3/08; E03C 1/12; A47B 2220/0091; A47L 2201/024; A47L 2201/028

(57) ABSTRACT

A robot cleaner station may include a housing located at a lower portion of kitchen furniture, a seating assembly located in the housing, the seating assembly being configured to accommodate a robot cleaner, a dust collector configured to empty dust of the robot cleaner, and a duster washer configured to wash a duster of the robot cleaner.

### CROSS REFERENCE TO RELATED APPLICATION

The present application claims priority to Korean Patent Application No. 10-2024-0016867, filed on Feb. 2, 2024, and Korean Patent Application No. 10-2023-0119850, filed on Sep. 8, 2023, in the Republic of Korea, the entire contents of which are incorporated herein for all purposes by this reference.

### BACKGROUND OF THE INVENTION

### Field of the Invention

The present disclosure relates to a robot cleaner station, and more specifically, to a built-in station, which may collect dust in a dust bin of a robot cleaner, wash a duster of the robot cleaner, and dry the duster when the robot cleaner is coupled.

### Description of the Related Art

Recently, with the development of an industrial technology, robot cleaners that clean while traveling in areas that need cleaning without user intervention are being developed.

These robot cleaners are provided with a sensor for recognizing a space to be cleaned, an agitator for sweeping and cleaning the floor, a duster for mopping the floor, etc. and may travel while suctioning dust on the floor of the space recognized by the sensor and mopping the floor using the duster, etc.

Among the robot cleaners, there are a dry robot cleaner capable of suctioning and removing a foreign substance scattered on the floor and a wet robot cleaner capable of mopping the floor using a moisture-containing duster to effectively remove a foreign substance attached to the floor. The dry robot cleaner is provided with a dust bin and suctions the foreign substance on the floor using a suction force of a suction motor. The wet robot cleaner is provided with a water container and is configured to effectively remove the foreign substance attached to the floor by mopping the floor in a state in which water stored in the water container is supplied to the duster and the duster contains moisture, which is then applied to the floor. In addition, there are robot cleaners in the form of having both an agitator and a duster.

A robot cleaner charging station is a device for docking a robot cleaner after the robot cleaner finishes cleaning. In addition, the robot cleaner charging station may charge a battery of the robot cleaner by supplying power to the battery installed in the robot cleaner. The charging station has a power supply module therein. The charging station has a charging terminal connected to the power supply module, and the robot cleaner has a corresponding terminal. When the charging terminal is in contact with the corresponding terminal, the battery is charged by receiving power.

Meanwhile, when the robot cleaner charging station is disposed inside a building, the charging station occupies a predetermined range of an indoor space. In this case, indoor space efficiency may be poor. In addition, a user or a pet may collide with the robot cleaner while passing by, thereby causing problems of injury to the user or the pet and damage to the robot cleaner.

In addition, a station with a dust collection function of the robot cleaner has a limitation in that it may damage an interior of the indoor as the space of the station increases.

In this regard, Chinese utility model registration CN219206761U discloses a device for washing a robot cleaner at the bottom of a washing machine.

The washing device may wash the robot cleaner using a lower space of the washing machine.

In addition, since the robot cleaner is washed using water supply and drain connected to the washing machine, separate water supply and drain structures are not required.

However, the washing device has a limitation in that it only washes the robot cleaner and does not have a function of charging the robot cleaner or collecting dust of the robot cleaner. Rather, there is a limitation that the risk of electric leakage may occur when the robot cleaner is washed while being charged.

Therefore, the washing device has limitations that it may be used only when washing the robot cleaner, may not provide a basic charging function, etc., and should have a separate charging station.

Meanwhile, Japanese Patent JP4916266B2 discloses a building that collects dust in a dust bin of a robot cleaner using a lower space of a wall.

The building has a dust collection device built into the lower space of the wall to collect the dust in the dust bin when the robot cleaner approaches.

However, since the building simply suctions air at a lower side of the wall, the dust is emptied in a state in which airtightness is not maintained between the building and the dust bin of the robot cleaner, and thus there is a limitation that dust may rather scatter indoors.

In addition, since the building may not supply power to the robot cleaner and should have a robot cleaner charging station, the effect of increasing indoor space efficiency is limited.

Meanwhile, Chinese utility model registration CN 2192708414 U discloses a cleaner station in which a robot cleaner is coupled to a lower side of a washing machine to charge the robot cleaner, collect dust, and wash a wet duster of the robot cleaner.

However, the cleaner station has an open space into which the robot cleaner may enter at a lower side of the washing machine, detergent and water supply devices for washing a wet duster are provided at a vertical upper side of the space into which the robot cleaner enters, and a dust bag is disposed on a side surface of the space into which the robot cleaner enters.

In the case of such arrangement, since an overall height of the cleaner station is high, there is a limitation that the station may not be mounted using a lower space of a cabinet including a kitchen sink.

In addition, since the cleaner station should be installed at the lower side of the washing machine, there are limitations that a space in which the washing machine is installed should be basically, necessarily provided and the installation space with a height exceeding a height of the washing machine and a height of the cleaner station should be provided in consideration of the height of the washing machine and the height of the cleaner station.

In addition, since the space of the cleaner station into which the robot cleaner enters is always open, dust may scatter in a process of collecting the dust in the dust bin of the robot cleaner, and wastewater may leak in a process of washing the duster of the robot cleaner.

### SUMMARY OF THE INVENTION

To achieve the objects, a robot cleaner station according to an embodiment of the present disclosure may be installed in a lower space of kitchen furniture.

In addition, the robot cleaner station according to an embodiment of the present disclosure may collect dust in a dust bin of the robot cleaner and wash a duster of the robot cleaner by including a dust collector configured to empty dust of the robot cleaner, and a duster washer configured to wash a duster of the robot cleaner.

In addition, the robot cleaner station according to an embodiment of the present disclosure may be connected to a water supply pipe and a drain pipe that are provided in a cabinet including plumbing to supply water to a water container and the duster of the robot cleaner and wash the duster of the robot cleaner.

Meanwhile, specific components of the robot cleaner station according to an embodiment of the present disclosure may be disposed in a horizontal direction to use a limited space formed on a lower portion of the cabinet including plumbing.

Specifically, the robot cleaner station may include a housing disposed in the lower portion of the cabinet including plumbing, a seating assembly which is disposed in the housing and in which the robot cleaner is accommodated, an entrance into which the robot cleaner is drawn, and a dust collector configured to collect the dust in the dust bin of the robot cleaner, wherein the entrance is disposed on a front surface of the housing, and the dust collector is disposed on a side surface of the entrance.

In addition, the robot cleaner station according to an embodiment of the present disclosure may further include a duster washer configured to wash the duster of the robot cleaner, wherein the duster washer is disposed on the side surface of the entrance.

In this case, the seating assembly is disposed between the dust collector and the duster washer.

Further, a dust bag of the dust collector may be provided to be drawn out forward from the housing.

In addition, a detergent container of the duster washer may be provided to be drawn out forward from the housing.

Meanwhile, the robot cleaner station according to an embodiment of the present disclosure may further include a duster dryer configured to dry the duster of the robot cleaner, wherein the duster dryer is disposed behind the seating assembly.

Meanwhile, the robot cleaner station according to an embodiment of the present disclosure may further include a door provided in the housing to open and close the entrance, wherein the door is disposed on the front surface of the housing. Therefore, it is possible to minimize external exposure of the robot cleaner station.

With this arrangement, when the robot cleaner is coupled to the seating assembly, at least a portion of the dust collector may be disposed to be lower than an uppermost end of the robot cleaner.

In addition, when the robot cleaner is coupled to the seating assembly, at least a portion of the duster washer may be disposed to be lower than the uppermost end of the robot cleaner.

In addition, when the robot cleaner is coupled to the seating assembly, at least a portion of the duster dryer may be disposed to be lower than the uppermost end of the robot cleaner.

In addition, in a state in which the robot cleaner is coupled to the seating assembly, the seating assembly may be partitioned into three areas in a vertical direction. In this case, the seating assembly may include a first area located on the same horizontal space as the detergent container, a second area disposed above the first area and located on the same horizontal space as at least a portion of the dust bag, and a third area disposed above the second area.

### BRIEF DESCRIPTION OF THE DRAWINGS

FIG. 1 is a view for describing a state in which a cleaner system according to an embodiment of the present disclosure is installed at a lower side of cabinet including plumbing.

FIG. 2 is a view for describing the relationship in which a pipe of the cleaner system according to the embodiment of the present disclosure is connected to a drain pipe.

FIGS. 3A and 3B are perspective views for describing the cleaner system according to the embodiment of the present disclosure.

FIG. 4 is a plan view of FIG. 3A.

FIG. 5 is a cross-sectional view along a front-rear direction of FIG. 3B.

FIG. 6 is a perspective view for describing a robot cleaner according to an embodiment of the present disclosure.

FIG. 7 is a side view of FIG. 6.

FIG. 8 is a bottom view of FIG. 6.

FIG. 9 is a rear view of FIG. 6.

FIG. 10 is a perspective view for describing a robot cleaner station according to an embodiment of the present disclosure.

FIG. 11 is a plan view of FIG. 10.

FIG. 12 is a side view for describing a dust collection flow path of the robot cleaner station according to the embodiment of the present disclosure.

FIGS. 13 to 16 are cross-sectional views for describing the dust collection flow path of the robot cleaner station according to the embodiment of the present disclosure.

FIG. 17 is a cross-sectional view showing a discharge hole of a dust collection motor housing of the robot cleaner station according to the embodiment of the present disclosure.

FIGS. 18 to 20 are views for describing a circulation flow path of the robot cleaner station according to the embodiment of the present disclosure.

FIGS. 21 and 22 are views showing a state in which a portion of a bottom surface of a floor member body has been removed to describe the circulation flow path of the robot cleaner station according to the embodiment of the present disclosure.

FIG. 23 is a perspective view for specifically describing area A shown in FIG. 22.

FIG. 24 is an enlarged view for describing a duster washer of the robot cleaner station according to the embodiment of the present disclosure.

FIG. 25 is an enlarged view for describing a washing water discharge unit of the duster washer of the robot cleaner station according to the embodiment of the present disclosure.

FIG. 26 is a cross-sectional perspective view for describing a space formed between a washing member and a washing member coupling unit of the robot cleaner station according to the embodiment of the present disclosure.

FIG. 27 is a perspective view for describing a duster dryer of a robot cleaner station according to a first embodiment of the present disclosure.

FIGS. 28 and 29 are enlarged views of a duster dryer of the robot cleaner station according to the first embodiment of the present disclosure.

FIG. 30 is a cross-sectional view for describing a state in which air flows inside a hot air supply module according to the first embodiment of the present disclosure.

FIG. 31 is a perspective view for describing a duster dryer of a robot cleaner station according to a second embodiment of the present disclosure.

FIGS. 32A and 32B are views for describing the arrangement relationship on a horizontal plane of the robot cleaner station according to the embodiment of the present disclosure.

FIG. 33 is a view showing a state in which a dust collector and a detergent container are drawn out from the robot cleaner station according to the embodiment of the present disclosure.

### DETAILED DESCRIPTION OF THE INVENTION

Hereinafter, exemplary embodiments of the present disclosure will be described in detail with reference to the accompanying drawings.

Since the present disclosure may have various changes and various embodiments, specific embodiments are shown in the accompanying drawings and specifically described in the detail descriptions. This is not intended to limit the present disclosure to specific embodiments and should be construed to include all modifications, equivalents, and substitutes included in the spirit and technical scope of the present disclosure.

In the description of the present disclosure, terms such as first and second may be used to describe various components, but the components may not be limited by the terms. The terms are used only for the purpose of distinguishing one component from another. For example, a second component may be referred to as a first component, and similarly, the first component may also be referred to as the second component without departing from the scope of the present disclosure.

The term “and/of” includes a combination of a plurality of related listed items or any of the plurality of related listed items.

When a first component is described as being “connected” or “coupled” to a second component, it can be understood that the first component may be directly connected or coupled to the second component, but a third component may be present therebetween. On the other hand, when the first component is described as being “directly connected” or “directly coupled” to the second component, it can be understood that the third component is not present therebetween.

The terms used in the present application are only used to describe specific embodiments and are not intended to limit the present disclosure. The singular expression includes the plural expression unless the context clearly dictates otherwise.

In the present application, it can be understood that terms “include” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those skilled in the art to which the present disclosure pertains. The terms defined in a generally used dictionary can be construed as meanings that match with the meanings of the terms from the context of the related technology and are not construed as an ideal or excessively formal meaning unless clearly defined in the present application.

In addition, the following embodiments are provided to provide a more complete description to those skilled in the art, and the shapes, sizes, etc. of elements in the drawings may be exaggerated for clearer description.

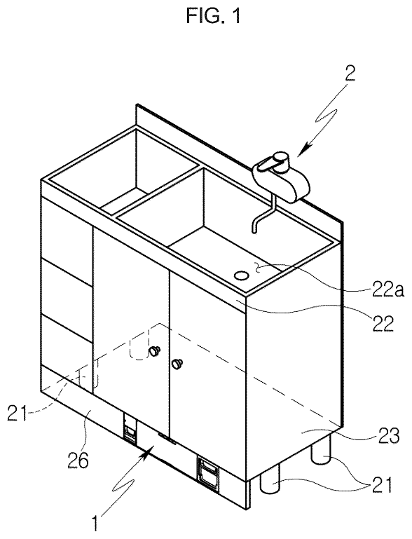

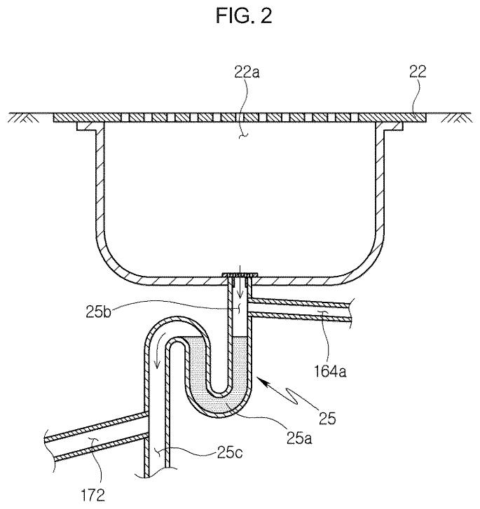

FIG. 1 is a view for describing a state in which a cleaner system according to an embodiment of the present disclosure is installed at a lower side of cabinet including plumbing, and FIG. 2 is a view for describing the relationship in which a pipe of the cleaner system according to the embodiment of the present disclosure is connected to a drain pipe.

A cleaner system 1 according to an embodiment of the present disclosure may be provided at a lower side of cabinet including plumbing 2. In an embodiment of the present disclosure, the cabinet including plumbing may be kitchen furniture or bathroom furniture. Regarding the cabinet with plumbing, the plumbing may be at least one of a sink pipe, a drain pipe, or a water supply pipe.

Specifically, when the cabinet including plumbing is kitchen furniture 2, the kitchen furniture 2 may be disposed in kitchen to store dishes, plates, cups, etc. and provide a space in which food may be cooked or the dishes may be washed. In addition, the kitchen furniture 2 may be provided with a top plate (worktop) that may function as a sink, a cooking table, or a worktop.

For example, the kitchen furniture 2 may include a kitchen sink, which provides a space in which the dishes may be washed, on the top plate. Alternatively, the kitchen furniture 2 may include a cooking table on which cooking operations are performed. In addition, the kitchen furniture 2 may include a gas range support on which a gas range, an induction, a highlight, an oven, etc. are installed. However, the present disclosure is not limited thereto. The cleaner system 1 can be disposed under any cabinet with plumbing.

In general, the kitchen furniture 2 may use a standard cabinet with 600 mm wide in a left-right direction and 600 mm wide in the front-rear direction. However, the present disclosure is not limited thereto.

The cleaner system 1 according to another embodiment of the present disclosure may be provided at a lower side of a structure including at least any one of a water supply pipe and a drain pipe. Specifically, the water supply pipe may be a flow path connected to an external water supply source for supplying a fluid to the structure, and the drain pipe may be a flow path through which fluid discharged from the structure is discharged to a sewer.

A lower portion of the kitchen furniture 2 or the structure may be provided with a storage cabinet for storing dishes, kitchen tools, etc. That is, the kitchen furniture 2 or the structure may include a top plate 22 that provides a space in which operations such as cooking or dish-washing may be performed, a bottom plate 23 disposed to be spaced a predetermined height from the ground, and a storage space formed between the top plate 22 and the bottom plate 23 to store dishes, kitchen tools, etc. In this case, when the kitchen furniture 2 is a kitchen sink, a sink 22a may be disposed on the top plate 22. However, in another embodiment, the cleaner system 1 may be disposed under any cabinet with a sink.

In addition, the bottom plate 23 may be supported by a pedestal 21. The pedestal 21 may be disposed in a direction perpendicular to the floor of the kitchen to support a load of the kitchen furniture 2. In this case, a space may be formed between the floor and the bottom plate 23 depending on a height of the pedestal 21.

Alternatively, the kitchen furniture 2 may be fixed to a building wall without the pedestal 21. Even in this case, a space may be formed between the floor and the bottom plate 23.

The cleaner system 1 according to the embodiment of the present disclosure is mounted in the space (hereinafter referred to as a mounting space 24) between the floor and the bottom plate 23 as described above.

For example, the mounting space 24 may have a height of 200 mm or less and generally have a height of 160 mm or less. However, the present disclosure is not limited thereto.

Therefore, according to an embodiment of to the present disclosure, since the cleaner system 1 is disposed in the lower space of the kitchen furniture 2, it is possible to minimize external exposure of the cleaner system 1.

In addition, compared to a robot cleaner charging station being disposed in a predetermined space of a living room, a room, or kitchen, the cleaner system 1 is disposed in an unused space formed by the cabinet with plumbing 2 without needing a separate space, and thus it is possible to maximize space efficiency.

Meanwhile, the kitchen furniture 2 or the structure is provided with a drain pipe 25 through which a liquid used for cooking or water used for dish-washing may drain. At least a portion of the drain pipe 25 may be disposed in the storage space formed between the top plate 22 and the bottom plate 23. In general, the drain pipe 25 may be connected to a drain port formed in the sink 22a of the kitchen sink. The drain pipe 25 includes a U-trap 25a for preventing a backflow of contaminated gas or odor. The U-trap 25a may be disposed in the storage space. A liquid introduced through the drain port flows downward due to gravity at an upstream side 25b of the U-trap, accumulates in the U-trap 25a, and when water rises a predetermined level or more set by the U-trap 25a, the water may flow downward along a downstream side 25c of the U-trap and may be discharged to a sewer. The cleaner system 1 according to the embodiment of the present disclosure may wash and dry a duster 242 of a robot cleaner 200 using the drain pipe 25.

In addition, the kitchen furniture 2 may be provided with a water supply pipe. Fresh water (or purified water) may be supplied to the cleaner system 1 through the water supply pipe.

Hereinafter, a specific structure of the cleaner system 1 will be described.

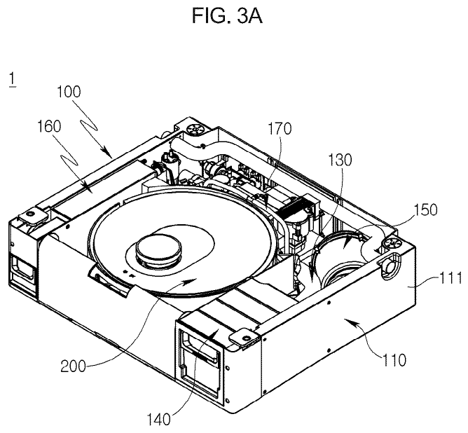

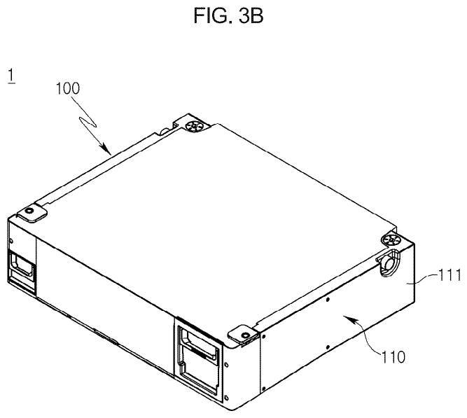

Meanwhile, FIGS. 3 to 5 are views for describing the cleaner system according to the embodiment of the present disclosure.

The cleaner system 1 according to the embodiment of the present specification may include a robot cleaner station 100 and the robot cleaner 200.

The cleaner system 1 includes the robot cleaner station 100. The robot cleaner 200 may be coupled to the robot cleaner station 100. Specifically, the robot cleaner 200 may enter a front entrance of the robot cleaner station 100, and the robot cleaner 200 may be accommodated inside the robot cleaner station 100. Additionally, the robot cleaner station 100 may remove dust in a dust bin 220 of the robot cleaner 200. Further, the robot cleaner station 100 may wash a rotational cleaning unit 240 of the robot cleaner 200. The robot cleaner station 100 may dry the rotational cleaning unit 240 of the robot cleaner 200. The robot cleaner station 100 may supply power to the robot cleaner 200.

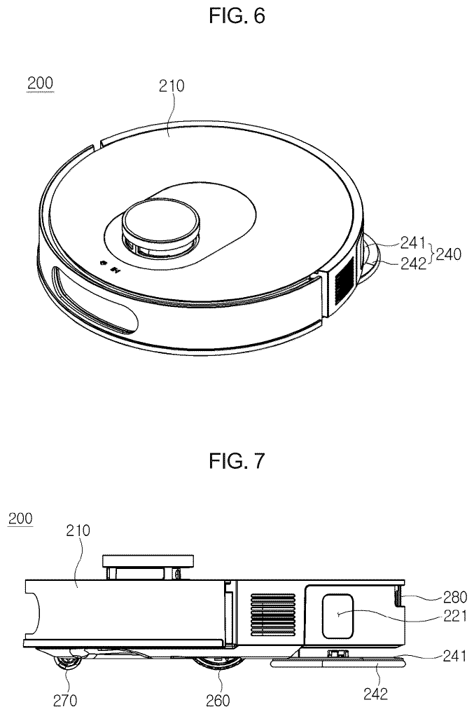

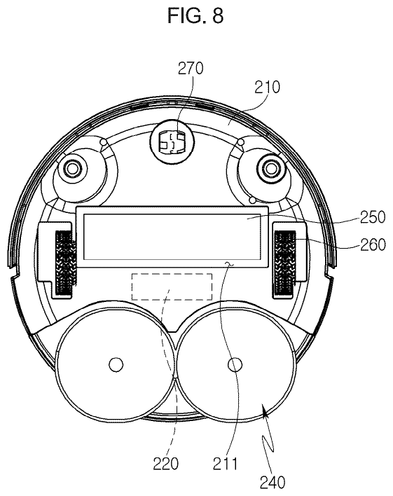

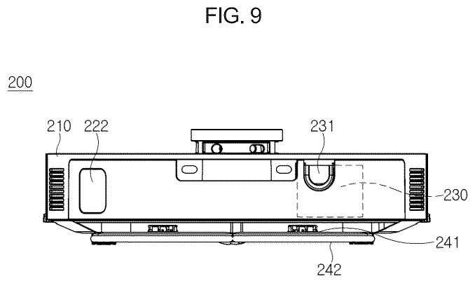

Meanwhile, FIGS. 6 to 9 are views for describing a robot cleaner in the cleaner system according to the embodiment of the present disclosure.

A structure of the robot cleaner 200 will be described with reference to FIGS. 6 to 9 as follows.

The robot cleaner 200 may automatically clean an area to be cleaned by suctioning a foreign substance, such as dust, from the floor while autonomously traveling in the area to be cleaned.

The robot cleaner 200 according to the embodiment of the present disclosure is disposed on the floor to clean the floor while moving along a floor surface. Therefore, the following description will be made by setting a vertical direction based on a state in which the robot cleaner 200 is disposed on the floor.

In addition, description will be made by setting a side at which an auxiliary wheel 270 to be described below is located as a front side and setting a side at which the rotational cleaning unit 240 to be described below is located as a rear side based on a pair of wheels 260.

A “lowest portion” of each component described in embodiments of the present disclosure may be a lowest portion of each component when the robot cleaner 200 according to the embodiment of the present disclosure is used by being disposed on the floor, or may be a portion closest to the floor.

The robot cleaner 200 according to the embodiment of the present disclosure includes a body 210, a dust bin 220, a water container 230, the rotational cleaning unit 240, an agitator 250, the wheel 260, the auxiliary wheel 270, and a charging terminal 280. The body 210 may form the overall appearance of the robot cleaner 200. Components of the robot cleaner 200 may be coupled to the body 210, and some components of the robot cleaner 200 may be accommodated inside the body 210.

Specifically, the body 210 may be provided with the components of the robot cleaner 200 in its internal space. As an example, the body 210 may accommodate a battery and at least one motor in the internal space.

In the embodiment of the present disclosure, the body 210 may have a shape in which a width (or a diameter) in a horizontal direction (direction parallel to X and Y) is greater than a height in a vertical direction (direction parallel to Z). The body 210 may support the robot cleaner 200 to have a stable structure and provide an advantageous structure for avoiding obstacles when the robot cleaner 200 moves (travels).

When viewed from top or bottom, the body 210 may have various shapes, such as a circular, elliptical, or quadrangular shape, however, the present disclosure is not limited thereto.

Additionally, the body 210 may be divided into a lower body and an upper body, and the lower body and the upper body may be coupled to form an internal space. The lower body may be coupled to the upper body to form a space in which a battery, at least one sensor, and at least one motor may be accommodated.

A hole for accommodating a suction unit 211 through which air is introduced and the pair of wheels 260 may be formed in the lower body.

The suction unit 211 may be a passage through which dust on the floor is introduced into the robot cleaner 200. In addition, the suction unit 211 may communicate with a suction flow path formed inside the body 210, and the suction flow path may communicate with an internal space of the dust bin 220.

Meanwhile, an exhaust flow path may be further provided in the lower body. The exhaust flow path may have one side communicating with the internal space of the dust bin 220 and the other side communicating with an exhaust port. In this case, a filter may be disposed on the exhaust port.

With this configuration, air introduced through the suction unit 211 may flow into the dust bin 220 through the suction flow path and may be discharged to the exhaust port through the exhaust flow path.

The agitator 250 to be described below may be rotatably accommodated in the suction unit 211. With this configuration, dust around the suction unit 211 may be guided into the suction unit 211 by the rotation of the agitator 250, and the efficiency of sucking the dust can be increased.

The upper body may form an upper appearance of the robot cleaner 200. Additionally, a display may be provided on the upper body.

Further, the robot cleaner 200 according to an embodiment of the present disclosure may include a bumper. The bumper is coupled along an edge of the body 210 and is configured to move relatively with respect to the body 210.

The bumper may be coupled along a portion of the edge of the body 210 or coupled along the entire edge of the body 210. At least one elastic member may be provided between the bumper and the body 210. With this configuration, when the bumper is in contact with an obstacle, etc. to move relatively toward the center of the body 210, the bumper may be returned to an original location by a restoring force of the elastic member and can prevent and reduce the transmission of an impact to the body 210 by absorbing or dispersing the impact applied to the bumper.

The dust bin 220 may be provided to store dust suctioned by the suction unit 211. The dust bin 220 may store dust introduced through the suction flow path. The dust bin 220 may have a dust inlet that communicates with the suction flow path, an internal space in which dust may be stored, and an air outlet through which air may be discharged. The dust bin 220 may be provided inside the body 210. In this case, the dust bin 220 may be not only coupled to the body 210 but also may be detachable according to an embodiment.

Meanwhile, in the present disclosure, a dust discharge flow path may be formed in the dust bin 220. The dust discharge flow path may allow the internal space of the dust bin 220 to communicate with an external space of the robot cleaner 200. With this configuration, when dust is collected through the robot cleaner station 100, the dust inside the dust bin 220 may be removed.

Meanwhile, a dust outlet 221 communicating with the dust discharge flow path may be formed in the dust bin 220 according to the embodiment of the present disclosure. As an example, the dust outlet 221 may be formed at one side of a rear outer surface (or an outer circumferential surface) of the body 210. As another example, the dust outlet 221 may be formed on an outer surface of the dust bin 220.

In addition, the robot cleaner 200 according to the embodiment of the present disclosure may be provided with a dust bin door 222 capable of selectively opening and closing the dust outlet 221. Specifically, the dust bin door 222 may be coupled to the body 210 and disposed at a location at which the dust outlet 221 may be blocked. As an example, the dust bin door 222 may be made of a rubber or resin material and provided in a flippable manner so that one side may be fixedly coupled to the body 210, however, the present disclosure is not limited thereto.

With this configuration, when a dust collection motor 152 of the robot cleaner station 100, which will be described below, is operated, the dust bin door 222 may be elastically deformed by a driving force of the dust collection motor 152, and as the dust outlet 221 is opened, the dust in the dust bin 220 may be collected in a dust collector 140 of the robot cleaner station 100.

Next, the water container 230 may be disposed in the form of a container having an internal space so that a liquid such as water is stored therein. The water container 230 may be disposed inside the body 210 and may be fixedly coupled to the body 210 or detachably coupled to the body 210.

The water container 230 includes a supply unit 231 and a nozzle. The supply unit 231 may be provided to supply an external liquid such as water. For example, the supply unit 231 may have an injection port formed at the other side of the rear outer surface (or the outer circumferential surface) of the body 210 and may be connected to a storage space inside the water container 230 through a water supply hose.

In this case, the supply unit 231 may be disposed at opposite sides in a left-right direction of the robot cleaner 200 in the relationship with the dust outlet 221. For example, when the dust outlet 221 is disposed at a rear left side of the body 210, the supply unit 231 may be disposed at a rear right side of the body 210.

With this configuration, the robot cleaner station 100 may simultaneously collect dust and inject water in a state in which the robot cleaner 200 is coupled to the robot cleaner station 100.

Meanwhile, the nozzle is formed in the form of a tube or a pipe and is connected to the water container 230 so that a liquid inside the water container 230 may flow through an inside of the nozzle. The nozzle may have one side connected to the water container 230 and the other end portion disposed to be located above a pair of rotational plates 241, and thus the liquid inside the water container 230 may be supplied to each of the pair of dusters 242.

That is, the nozzle may be formed in the form of one pipe branched into two, and in this case, an end portion of any one branched may be located above the left rotational plate, and an end portion of the other branched may be located above the right rotational plate.

Meanwhile, although not shown, the water container 230 may be provided with a pump to flow the water inside the water container 230 to the nozzle. Therefore, when the pump of the water container 230 is operated, the liquid stored in the water container 230 may be discharged to the rotational cleaning unit 240 through the nozzle.

The rotational cleaning unit 240 includes the rotational plate 241 and the duster 242. The rotational plate 241 may be provided as a pair of the left rotational plate and the right rotational plate, and the duster 242 may be provided as a pair of a left duster and a right duster. Further, the rotational plate 241 may be rotatably disposed on a bottom surface of the body 210, and the duster 242 may be coupled to a lower side thereof.

The rotational plate 241 is configured to have a predetermined area and is configured in the form of a flat plate, a flat frame, etc. The rotational plate 241 is generally laid horizontally, and thus has a shape in which a width (or a diameter) in a horizontal direction is sufficiently greater than a height in a vertical direction. The rotational plate 241 coupled to the body 210 may be parallel to a floor surface B or may be inclined to the floor surface B. The rotational plate 241 may be formed in a circular plate shape, a bottom surface of the rotational plate 241 may be generally circular, and the rotational plate 241 may be entirely symmetrical rotationally, however, the present disclosure is not limited thereto. In addition, the pair of rotational plates 241 may be symmetrical.

The duster 242 may be coupled to the lower side of the rotational plate 241 to face the floor surface B. The duster 242 is formed so that the bottom surface facing the floor has a predetermined area, and the duster 242 is formed in a flat shape. The duster 242 is formed in a shape in which a width (or a diameter) in a horizontal direction is sufficiently greater than a height in a vertical direction. When the duster 242 is coupled to the body 210 side, the bottom surface of the duster 242 may be parallel to the floor surface B or inclined to the floor surface B.

The bottom surface of the duster 242 may be generally circular, and the duster 242 may be entirely symmetrical rotationally. In addition, the duster 242 may be detachably attached to the bottom surface of the rotational plate 241 and coupled to the rotational plate 241 to rotate together with the rotational plate 241.

Meanwhile, although not shown, the rotational cleaning unit 240 may be provided with a driving unit for applying a rotational force to the rotational plate 241. For example, the driving unit may include a motor and at least one gear. Therefore, when the driving unit is operated, the rotational plate 241 and the duster 242 rotate to mop and clean the floor surface B.

Next, the agitator 250 may be rotatably provided with a plurality of brushes to guide external dust and air to the dust bin 220. In this case, the agitator 250 may be provided with at least one gear.

Meanwhile, the agitator 250 according to the present embodiment may be provided with a separate agitator motor to receive rotational power and according to an embodiment, may receive rotational power from a driving motor, and may receive rotational power from the driving unit of the rotational cleaning unit 240.

The wheel 260 may be provided on the bottom surface of the body 210 and connected to the driving unit. In this case, the driving unit may be coupled to the body 210. The wheel 260 may be provided on the body 210 and may roll on the floor surface B.

The wheel 260 may be composed of a first driving wheel and a second driving wheel. In this case, the first driving wheel may be configured identically to or symmetrically to the second driving wheel. As an example, when the first driving wheel is located at the left side of the robot cleaner 200, the second driving wheel may be located at the right side of the robot cleaner 200, and in this case, the first driving wheel and the second driving wheel may be symmetrical in a left-right direction.

The driving unit may include a driving motor and a gear. In this case, the driving motor may be accommodated inside the body 210 and may provide power to the wheel 260. The driving motor may include a first driving motor and a second driving motor.

The driving motor may be configured as an electric motor. A plurality of gears are configured by being engaged to rotate, connect the driving motor to the wheel 260, and transmit the rotational power of the driving motor to the wheel 260. Therefore, the wheel 260 may rotate when a rotation shaft of the driving motor rotates.

With this configuration, when the driving motor is operated, the wheel 260 may rotate, and the body 210 may travel at a predetermined traveling speed on the floor surface B.

The auxiliary wheel 270 may be provided on a lower surface of the body 210 and may roll on the floor surface B (surface to be cleaned). The auxiliary wheel 270 may support the body 210 on the floor surface B together with the pair of wheels 260. With this configuration, the auxiliary wheel 270 can minimize friction between the robot cleaner 200 and the floor surface B and at the same time, guide the movement of the robot cleaner 200.

The suction motor may generate a suction force capable of suctioning external dust and air through the suction unit 211. As an example, the suction motor may be an electric motor. External dust and air may flow into the suction unit 211 by the suction force generated by the suction motor and reach the dust bin 220 after passing through the suction flow path.

Although not shown, the battery is coupled to the body 210 to supply power to other components of the robot cleaner 200. The battery may supply power to at least one motor provided in the robot cleaner 200. For example, the battery may supply power to motors provided in the rotational cleaning unit 240, the agitator 250, the wheel 260, and the suction motor. In addition, the battery may supply power to a sensor unit and a control unit.

The battery may be charged by an external power source, and to this end, the charging terminal 280 for charging may be provided at one side of the body 210. For example, the charging terminal 280 may be disposed on the rear outer surface of the body 210. When the robot cleaner 200 is coupled to the robot cleaner station 100, the charging terminal 280 may receive power by being in contact with a power supply terminal 123b of the robot cleaner station 100.

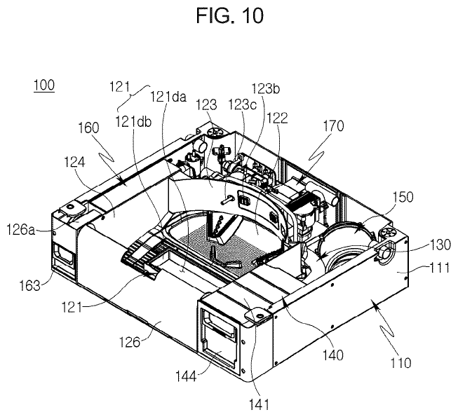

FIG. 10 is a perspective view for describing a robot cleaner station according to an embodiment of the present disclosure, and FIG. 11 is a plan view of FIG. 10.

The robot cleaner station 100 according to an embodiment of the present disclosure will be described with reference to FIGS. 10 and 11 as follows.

The robot cleaner 200 may be accommodated in the robot cleaner station 100. The robot cleaner 200 may be coupled to a seating assembly 120 of the robot cleaner station 100. Further, the seating assembly 120 may also be known as a seat unit.

The robot cleaner station 100 may include a housing 110. The housing 110 may form the appearance of the robot cleaner station 100. As an example, the housing 110 may be formed in a shape similar to a hexahedron including at least one outer wall surface.

The housing 110 may include the seating assembly 120, a dust collection flow path 130, the dust collector 140, the dust collection motor 152, a duster washer 160, a duster dryer 170, and a circulation flow path 125a.

The housing 110 may be mounted at the lower side of the cabinet with plumbing 2. Specifically, the housing 110 may be installed in the mounting space 24 formed between the bottom plate 23 of the cabinet with plumbing 2 and the floor.

The housing 110 includes a pair of outer wall surfaces 111 facing each other. The outer wall surface 111 may be a surface formed in a direction of gravity.

As an example, the pair of outer wall surfaces may be installed at the lower side of the cabinet with plumbing 2 at a predetermined interval. As another example, the housing 110 may further include a bottom surface facing the floor, and the pair of outer wall surfaces may be connected through the bottom surface. As still another example, the housing 110 may further include a bottom surface facing the floor and a top surface facing the lower plate 23 of the cabinet with plumbing 2, and both upper and lower end portions of the pair of outer wall surfaces may be connected through the bottom surface and the top surface. As still another example, the housing 110 may further include the bottom surface, the top surface, and a rear surface facing a building wall.

With this configuration, the components of the robot cleaner station 100 may be accommodated inside the housing 110 (between the pair of outer wall surfaces).

Meanwhile, the housing 110 may be disposed in a form in which the upper and lower surfaces of the pair of outer wall surfaces 111 are closed by a housing cover. With this configuration, even when a foreign substance falls downward from the cabinet with plumbing 2, the components of the robot cleaner 200 and the robot cleaner station 100 are not impacted by the foreign substance and can be prevented from being contaminated.

In addition, the robot cleaner 200 may be accommodated inside the housing 110. The housing 110 may be disposed so that the pair of outer wall surfaces have a gap greater than a maximum width of the robot cleaner 200 in a horizontal direction. With this configuration, the robot cleaner 200 may enter and exit the housing 110.

In this case, in the present embodiment, the robot cleaner 200 may enter and exit the front of the robot cleaner station 100. Here, the front may be a direction in which a door 126 is provided with respect to the inside of the robot cleaner station 100.

In addition, the rear may be a direction opposite to the front with respect to the inside of the robot cleaner station 100. For example, a building wall may be disposed at the rear of the robot cleaner station 100. Additionally, a rear of the cabinet with plumbing 2 may correspond to the rear of the robot cleaner station 100.

In addition, a left side may be referred to as a left room, and a right side may be referred to as a right room with respect to when viewing the front from the inside of the robot cleaner station 100. That is, the outer wall surface of the robot cleaner station 100 may be disposed in each of the left room and the right room.

Therefore, the top side of the housing 110 may be covered by the cabinet with plumbing 2, and the bottom side of the housing 110 may be covered by the floor. In addition, left and right surfaces of the housing 110 are present in a state of being covered with the outer wall, but are disposed in the lower portion of the cabinet with plumbing 2. In this case, since a portion excluding the robot cleaner station 100 of the lower portion of the cabinet with plumbing 2 is finished by a baseboard 26, as a result, only a front surface of the housing 110 may be exposed to the outside of the cabinet with plumbing 2. Therefore, it is possible to minimize external exposure of the robot cleaner station 100 and the robot cleaner 200. With this configuration, the robot cleaner station 100 according to an embodiment of the present disclosure can provide an aesthetic sense to a user in terms of an interior design.

Meanwhile, a space through which a water supply hose connected to the water supply pipe passes and a space through which a drain hose through which wastewater generated after cleaning the duster 242 is discharged passes may be disposed in the housing 110, and a space through which ahose through which moisture generated in the drying process for the duster 242 is discharged passes may be disposed therein. For example, a space through which the hoses may pass may be formed in at least one of the outer wall surface, rear surface, and top surface of the housing 110.

In addition, the robot cleaner station 100 may include the seating assembly 120. The robot cleaner 200 and the robot cleaner station 100 may be connected through the seating assembly 120 in a physical, electrical, and/or flow path manner. The seating assembly 120 may be disposed inside the housing 110. In this case, according to an embodiment, the seating assembly 120 may be provided to be drawn out from the housing 110 through a drawer 190. With this configuration, when the seating assembly 120 needs to be washed or repaired or some components thereof need to be replaced, the user may easily draw out and manage the seating assembly 120.

An entrance 127 through which the robot cleaner 200 is may enter or exit the seating assembly 120 may be disposed in the front of the housing 110.

The entrance 127 may be disposed in a size that may allow the robot cleaner 200 to pass therethrough. That is, a height of the entrance 127 is disposed to be greater than a height of the robot cleaner 200. In this case, the entrance 127 may be a space disposed upward in the vertical direction from a front end portion of a bottom member 121 to be described below, and an upper end of the entrance may be a bottom surface of the bottom plate 23 or an upper end of the housing 110 of the cabinet with plumbing 2.

In addition, the entrance 127 is disposed to have a width in a left-right direction greater than the maximum width of the robot cleaner 200. In this case, at least one of the dust collector 140 and the duster washer 160 may be disposed at left and right sides of the entrance 127. Therefore, left and right end portions of the entrance 127 may form a boundary with the dust collector 140 and the duster washer 160. When any one of the dust collector 140 and the duster washer 160 is not present, an outer wall surface of the housing 110 may become a boundary. Further, the dust collector 140 may also be known as a dust collection unit.

In this case, the entrance 127 may be opened and closed by the door 126. The door 126 may be disposed at the upper end of the entrance 127 and provided with a rotational shaft in a direction parallel to the bottom member 121. The door 126 may be hinge-coupled to the housing 110. Alternatively, the door 126 may be hinge-coupled to a side wall 124 of the seating assembly 120. The door 126 may be rotated by a door driving unit 126a. As an example, the door driving unit 126a may be a motor.

For example, the door 126 may be disposed as a rectangular flat plate and may have the upper end provided with a hinge unit 126b, and the door driving unit 126a may be connected to one end portion of the hinge unit 126b in an axial direction. In this case, the hinge unit 126b of the door 126 may be directly connected to a shaft of the door driving unit 126a and connected to transmit power through at least one gear.

The door 126 may maintain a closed state of the entrance 127 in a state in which the robot cleaner 200 is accommodated in the seating assembly 120. In addition, when the robot cleaner 200 starts traveling from the seating assembly 120, the robot cleaner 200 may be rotated to open the entrance 127. Further, the door 126 may be rotated to close the entrance 127 after the robot cleaner 200 passes through the entrance 127. In addition, the door 126 may be rotated to open the entrance 127 when the robot cleaner 200 approaches the cleaner station 100 from the outside.

The seating assembly 120 may include an accommodation space S, the bottom member 121, a coupling wall 123, and the side wall 124.

The robot cleaner 200 may be accommodated in the accommodation space S of the seating assembly 120. As an example, the accommodation space S may be a space surrounded by the bottom member 121, the coupling wall 123, and the side wall 124. As another example, the accommodation space S may be a space surrounded by the bottom member 121, a washing member 122, the coupling wall 123, and the side wall 124. As still another example, the accommodation space S may be a space in which the robot cleaner 200 is located in a state in which the robot cleaner 200 is coupled to the power supply terminal 123b or a space in which the robot cleaner 200 is located in a state in which the dust bin 220 of the robot cleaner 200 communicates with a dust through hole 123a.

The bottom member 121 is a component that may be disposed so that the robot cleaner station 100 is in contact with the floor surface B and may support the robot cleaner 200 when the robot cleaner 200 is coupled to the robot cleaner station 100. The bottom member 121 may include a bottom member body 121a, an inclined portion 121b, a wheel coupling portion 121c, an agitator accommodation portion 121d, and a washing member coupling portion 121e.

The bottom member body 121a may form the overall appearance of the bottom member 121. The inclined portion 121b, the wheel coupling portion 121c, the agitator accommodation portion 121d, and the washing member coupling portion 121e may be disposed on the bottom member body 121a.

The bottom member body 121a may have a shape in which a width (or a diameter) in a horizontal direction (direction parallel to X and Y) is greater than a height in a vertical direction (direction parallel to Z). With this structure, the robot cleaner station 100 can be stably supported on the floor surface B.

A circulation flow path 125a may be provided inside the bottom member body 121a. Therefore, the air discharged from the dust collection motor 152 may flow through the circulation flow path 125a formed inside the bottom member body 121a and may be exhausted through an exhaust port 125b.

The inclined portion 121b may be disposed at an inlet of the bottom member body 121a, the inclined portion 121b being a portion where the robot cleaner 200 moves upward. The inclined portion 121b may have upward inclination forward in a direction in which the robot cleaner 200 enters. More specifically, the inclined portion 121b may be connected so that a front end portion of the inlet side has no difference in height from the ground and may have upward inclination forward in the direction in which the robot cleaner 200 enters. Therefore, the robot cleaner 200 may easily move upward from the ground to the robot cleaner station 100.

The inclined portion 121b may be provided with a wheel guide portion 121ba. The wheel guide portion 121ba may be formed in the form of a groove to guide the movement of the wheels 260 of the robot cleaner 200. A surface of the wheel guide portion 121ba may be disposed to correspond to a surface of the wheel 260 so that the robot cleaner 200 may travel stably. In addition, the wheel guide portion 121ba may be disposed to have a width of the groove greater than a width of the wheel 260 at the inlet at which the robot cleaner 200 moves upward and disposed to have the smaller width of the groove compared to the inlet forward from an upward movement path of the robot cleaner 200. Therefore, the wheel 260 of the robot cleaner 200 may easily enter the robot cleaner station 100, and due to the restriction to the left and right movement by the groove with a gradually decreasing width, the wheel 260 may be guided to a correct location.

The inclined portion 121b may be provided with an auxiliary wheel guide portion 121bb. The auxiliary wheel guide portion 121bb may be disposed as a groove to guide the movement of the auxiliary wheel 270 of the robot cleaner 200. In addition, the auxiliary wheel guide portion 121bb may be disposed to protrude to be in contact with the auxiliary wheel 270 when the wheels 260 of the robot cleaner 200 is seated on the wheel guide portion 121ba. Therefore, when the robot cleaner 200 travels on the inclined portion 121b, the robot cleaner 200 may travel while being stably supported by both the wheels 260 and the auxiliary wheel 270.

The wheels 260 of the robot cleaner 200, which move upward along the wheel guide portion 121ba, may be seated on the wheel coupling portions 121c. When the wheels 260 of the robot cleaner 200 are seated on the wheel coupling portions 121c, the robot cleaner 200 and the robot cleaner station 100 may be physically coupled. A surface of the wheel coupling portion 121c may be disposed to correspond to a surface of the wheel 260 so that the robot cleaner 200 may stop stably. The wheel coupling portion 121c may extend from an upper end of the wheel guide portion 121ba. The wheel coupling portion 121c may be connected to the wheel guide portion 121ba without any step. Therefore, the robot cleaner 200 may easily move to the wheel coupling portion 121c through the inclined portion 121b.

The wheel coupling portion 121c may be disposed at stop locations of the left and right wheels 260 of the robot cleaner 200 so that the robot cleaner 200 stops at a correct location. Here, the stop locations of the wheels 260 are locations determined so that the robot cleaner 200 stops so as to be coupled to the power supply terminal 123b and/or locations determined so that the dust bin 220 of the robot cleaner 200 stops so as to communicate with the dust through hole 123a.

A shape of the wheel coupling portion 121c may be disposed in a shape corresponding to the shape of the wheel 260 of the robot cleaner 200, that is, an arch shape. With this configuration, the robot cleaner 200 may move along the wheel guide portion 121ba and then stop at the same time as the wheels 260 are inserted into the wheel coupling portions 121c, and the wheels 260 may be stably seated on the arch-shaped wheel coupling portions 121c.

The agitator 250 of the robot cleaner 200 may be accommodated in the agitator accommodation portion 121d. Specifically, the agitator accommodation portion 121d may provide a space in which the agitator 250 of the robot cleaner 200 is accommodated in a state in which the wheels 260 of the robot cleaner 200 are seated on the wheel coupling portions 121c.

The agitator accommodation portion 121d may include a recess 121da and a protrusion 121db. The recess 121da may be disposed to be recessed in the bottom member 121. The recess 121da may form an accommodation space 121dc in which at least a portion of the agitator 250 is accommodated. Therefore, in a state in which the wheels 260 of the robot cleaner 200 are seated on the wheel coupling portions 121c, at least a portion of the agitator 250 may be accommodated in the accommodation space 121dc of the recess 121da.

The accommodation space 121dc of the recess 121da may communicate with the accommodation space S of the seating assembly 120.

The exhaust port 125b may be disposed at one side of the recess 121da. Specifically, the exhaust port 125b may be disposed on a side surface of the recess 121da. Therefore, the air discharged from the dust collection motor 152 and passing through the circulation flow path 125a may be exhausted to the accommodation space 121dc of the recess 121da through the exhaust port 125b.

Further, the protrusion 121db may be disposed to protrude from the bottom member 121. The protrusion 121db may be disposed along an edge of the recess 121da. In addition, in a state in which the agitator 250 is accommodated in the accommodation space 121dc of the recess 121da, the protrusion 121db may be disposed to be spaced a predetermined distance from the body 210 of the robot cleaner 200.

The protrusion 121db may guide the air discharged through the exhaust port 125b to the suction unit 211 of the robot cleaner 200. Therefore, the air discharged to the accommodation space 121dc of the recess 121da may be guided to the suction unit 211 of the robot cleaner 200 by the protrusion 121db.

In addition, the agitator accommodation portion 121d may be disposed between the wheel coupling portions 121c. The agitator accommodation portion 121d may be disposed in a shape corresponding to the agitator 250 of the robot cleaner 200. The agitator accommodation portion 121d may be disposed in a rectangular parallelepiped shape with an open top, however, the present disclosure is not limited thereto. A lower surface of the agitator accommodation portion 121d may be sealed by the bottom surface of the bottom member body 121a or the bottom surface of the housing 110. Therefore, the agitator 250 of the robot cleaner 200, which moves upward along the inclined portion 121b, may be seated in the recess 121da through the open upper surface of the agitator accommodation portion 121d. In this case, a depth of the recess 121da may be formed to be smaller than a depth of the wheel coupling portion 121c.

The exhaust port 125b may be disposed in the agitator accommodation portion 121d. The exhaust port 125b may be disposed on a side surface of the agitator accommodation portion 121d. The exhaust port 125b may connect the recess 121da of the agitator accommodation portion 121d to the dust collection motor 152 through the circulation flow path 125a. The recess 121da of the agitator accommodation portion 121d may communicate with the circulation flow path 125a through the exhaust port 125b. Therefore, the air discharged from the dust collection motor 152 may pass through the exhaust port 125b and may be discharged to the recess 121da of the agitator accommodation portion 121d.

Next, the coupling wall 123 is a component on which the dust through hole 123a, the power supply terminal 123b, and a water supply nozzle 123c of the robot cleaner station 100 are disposed. The coupling wall 123 may spatially separate the accommodation space S from the components of the robot cleaner station 100. The coupling wall 123 may extend from the rear side of the bottom member 121 in a direction intersecting the bottom member 121. Further, the coupling wall 123 may extend from the rear side of the bottom member 121 in a vertical direction. The coupling wall 123 may be disposed to correspond to the shape of the robot cleaner 200. For example, the coupling wall 123 may be disposed in an arc shape having a predetermined radius. With this configuration, the outside of the robot cleaner 200 can be surrounded, and an area capable of facing the outer surface of the robot cleaner 200 can be increased. In addition, the robot cleaner 200 can be stably supported.

The dust through hole 123a may be disposed in the seating assembly 120 so that external air of the housing 110 may flow therein. Specifically, the dust through hole 123a may be disposed in the coupling wall 123 of the seating assembly 120 so that external air of the housing 110 may flow therein. The dust through hole 123a may communicate with the dust bin 220 of the robot cleaner 200. The dust through hole 123a may communicate with the dust outlet 221 of the dust bin 220 of the robot cleaner 200. Further, the dust through hole 123a may be disposed in a hole shape corresponding to the shape of the dust bin 220 so that the dust in the dust bin 220 flows into the dust collector 140. The dust through hole 123a may be disposed to correspond to the shape of the dust outlet 221 of the dust bin 220. In addition, the dust through hole 123a may be disposed to communicate with the dust collection flow path 130. The air suctioned into the dust through hole 123a may flow through the dust collection flow path 130 and then may be exhausted through an exhaust unit 125.

The power supply terminal 123b may supply power to the robot cleaner 200 coupled to the seating assembly 120. The power supply terminal 123b may be electrically connected by being in contact with the charging terminal 280 of the robot cleaner 200. The power supply terminal 123b may be disposed in the seating assembly 120. Specifically, the power supply terminal 123b may be disposed on the coupling wall 123.

The robot cleaner station 100 may further include a water supply nozzle 123c. The water supply nozzle 123c may be connected to the supply unit 231 of the water container 230 of the robot cleaner 200. Specifically, the water supply nozzle 123c may be connected to the injection port of the water container 230. The injection port is a component connected to the water container 230 of the robot cleaner 200. The water supply nozzle 123c may supply water supplied from the water supply pipe of the cabinet including plumbing 2 to the storage space inside the water container 230 of the robot cleaner 200.

Next, the side wall 124 is a component for spatially separating the accommodation space S of the seating assembly 120 from the components of the robot cleaner station 100. A pair of side walls 124 may be disposed at the left and right sides of the bottom member 121. The side wall 124 may be connected to both ends of the coupling wall 123. The side wall 124 may extend from the left and right sides of the bottom member 121 in a direction intersecting the bottom member 121. Specifically, the side wall 124 may extend from the left and right sides of the bottom member 121 in a vertical direction. A height of the side wall 124 may be disposed to correspond to the height of the pedestal 21. Specifically, the height of the side wall 124 may be formed to be the same as the height of the pedestal 21.

Meanwhile, various components such as the dust collection flow path 130, the dust collector 140, the dust collection motor 152, a detergent container 163, and a wastewater container 164 may be disposed outside the side wall 124. Specifically, the dust collector 140, the detergent container 163, and the wastewater container 164 may be accommodated in a space between the side wall 124 and the outer wall surface of the housing 110.

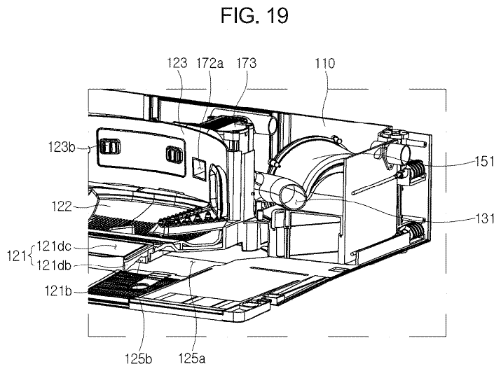

The dust collector 140 and the detergent container 163 may be separated from the space between the side wall 124 and the outer wall surface of the housing 110 in a sliding manner (see FIG. 19). Widths of the dust collector 140 and the detergent container 163 in a left-right direction may be disposed to correspond to a distance between the side wall 124 and the outer wall surface of the housing 110.

The washing member coupling portion 121e is a component in which the washing member 122 to be described below is seated. The washing member coupling portion 121e may be disposed at a rear side of the bottom member body 121a. The washing member coupling portion 121e may be disposed to correspond to the washing member 122 so that the washing member 122 may be inserted.

The washing member 122 is a component for washing the duster of the robot cleaner 200, and the washing member 122 may be seated on the washing member coupling portion 121e of the bottom member 121.

A protrusion 122a and a drain hole 122b may be disposed in the washing member 122. When the driving unit of the rotational cleaning unit 240 is driven in a state in which the duster 242 of the robot cleaner 200 is seated on the washing member 122, the duster 242 rotates. In this case, when the duster 242 rotates in a state in which washing water is supplied to the washing member, the duster 242 may be washed while rubbing against the protrusion 122a, which stays in a stationary state.

In addition, the washing member 122 may be disposed to be inclined downward toward the center thereof. Therefore, the washing water flowing along the inclined washing member 122 may wash the duster 242 and then may be discharged to a space formed between the washing member 122 and the washing member coupling portion 121e through the drain hole 122b.

The dust collector 140 may collect dust from the dust bin 220 of the robot cleaner 200. The dust collection part 140 may be disposed inside the housing 110. The dust collector 140 may be disposed outside the seating assembly 120. In this case, the accommodation space S may be disposed inside the seating assembly 120.

The dust collector 140 may include a dust collector housing 141, a dust bag, a filter 142, and a dust bag drawer 144. The dust collector housing 141 may form a space in which the dust bag, the filter 142, and the dust bag drawer 144 may be accommodated therein.

The dust collector housing 141 may be coupled to the dust bag drawer 144 therein so that the dust bag drawer 144 may be drawn out therefrom, and the dust bag may be stored inside the dust bag drawer 144. For example, the dust collector housing 141 may be formed in the form of a rectangular pipe with an open front, and a rear internal space may communicate with a first flow path 131 and a second flow path 132.

The dust collector housing 141 may have an internal one side communicating with the first flow path 131 and an other side communicating with the second flow path 132. In addition, when the dust bag is coupled to the dust collector housing 141, the dust bag may communicate with the first flow path 131 inside the dust collector housing 141.

The dust bag may be a dust bag for collecting dust suctioned from the inside of the dust bin 220 of the robot cleaner 200 by the dust collection motor 152. The dust bag may be detachably coupled to the dust collector housing 141. Therefore, the dust bag may be separated from the dust collector housing 141 and discarded, and a new dust bag may be coupled to the dust collector housing 141. That is, the dust bag can be defined as a disposable component.

Further, the dust bag may be provided so that dust is accommodated therein as a volume is increased when a suction force is generated by the dust collection motor 152.

To this end, the dust bag may be made of a material that allows air to be filtered but does not allow a foreign substance such as dust to be filtered. For example, the dust bag may be made of a non-woven material and may have a hexahedral shape corresponding to a shape of the dust collector housing 141 based on when the volume is increased, however, the present disclosure is not limited thereto.

Alternatively, the dust bag may be made of a non-permeable material. For example, the dust bag may include roll vinyl, however, the present disclosure is not limited thereto. With this configuration, when the dust bag is sealed or bonded, dust or odor collected inside the dust bag can be prevented from leaking from the dust bag. In this case, the dust bag may be mounted on the dust collector housing 141 through a dust bag cartridge. If necessary, the dust bag may be replaced through the dust bag cartridge.

The filter 142 may be disposed between the dust collector housing 141 and the second flow path 132. The filter 142 may be disposed at an outlet 141b. The filter 142 may be a pre filter or a HEPA filter. Air passing through the dust bag may flow into the second flow path 132 through the filter 142.

The filter 142 may be disposed between the dust collector housing 141 and the second flow path 132. The filter 142 may be disposed at an outlet 141b. The filter 142 may be a pre filter or a HEPA filter. The air passing through the dust bag may flow into the second flow path 132 through the filter 142.

The dust bag drawer 144 may be coupled to be drawn out from the dust collector housing 141, and the dust bag may be accommodated therein. In this case, the dust bag drawer 144 includes a dust bag drawer body 144a, a handle 144d, and a drawer rail 144e.

The dust bag drawer body 144a may provide a space in which the dust bag may be coupled. For example, the dust bag drawer body 144a may be formed in the form of a box with an open top, and an inlet 144b and an outlet 144c may be formed to communicate with the first flow path 131 and the second flow path 132 at the rear of the dust bag drawer body 144a.

For example, the dust bag drawer body 144a may be formed to have different widths of upper and lower sides in the left-right direction. For example, the width of the upper side of the dust bag drawer body 144a in the left-right direction may be formed to be greater than the width of the lower side in the left-right direction. That is, the inside of the dust bag drawer body 144a may be formed to have a stage. Therefore, an upper space in which the dust bag is provided can be maximized, and a flow path may be formed so that the air passing through the dust bag may be easily discharged downward.

The upper side of the dust bag drawer body 144a may communicate with the first flow path 131 through the inlet 144b. The inlet 144b may be a component for guiding air flowing through the first flow path 131 into the dust bag. The inlet 144b may communicate with the first flow path 131 and the dust bag. Therefore, dust suctioned from the dust bin 220 of the robot cleaner 200 may move into the dust bag through the first flow path 131 and the inlet 144b.

The dust bag drawer 144 may communicate with the second flow path 132 through the outlet 144c formed on a lower side surface thereof. The outlet 144c may be a component for guiding the air passing through the dust bag drawer 144 to the second flow path 132. The outlet 144c may be disposed at a different height from the inlet 144b. The outlet 144c may be disposed to be lower than the inlet 144b. The outlet 144c may allow an internal space of the dust bag drawer 144 to communicate with the second flow path 132. Therefore, the air in which dust has been filtered while passing through the dust bag may move to the second flow path 132 through the outlet 144c.

The handle 144d may be provided at the front of the dust bag drawer body 144a. The handle 144d may be provided so that a user may grip the same. For example, the handle 144d may include a pair of coupling portions hinge-coupled to a front surface of the dust bag drawer body 144a and a grip portion formed to be gripped by the user by connecting the pair of coupling portions.

With this configuration, when the user grips the grip portion and pulls the same forward, the dust bag drawer body 144a may be drawn out by being pulled forward together. Therefore, according to an embodiment of the present disclosure, the user may easily pull the dust bag drawer 144 forward, and then move the dust bag upward and remove and replace the same.

Next, a drawer rail 144e may be disposed on side surfaces of the dust bag drawer body 144a in the left-right direction. The drawer rail 144e may guide the movement of the dust bag drawer body 144a. For example, the drawer rail 144e may be disposed in the form of a groove or a rib in the front-rear direction on the side surfaces of the dust bag drawer body 144a in the left-right direction.

With this configuration, when the user couples the dust bag drawer 144 to the dust collector housing 141, the dust bag drawer 144 may be coupled at a correct location, and the dust collector 140 may be connected to the first flow path 131 and the second flow path 132 at correct locations, thereby reducing flow loss.

Meanwhile, a rail 141a may be disposed on an inner surface of the dust collector housing 141 corresponding to the drawer rail 144e. The rail 141a of the dust collector housing 141 may be disposed to correspond to the shape and location of the drawer rail 144e. For example, when the drawer rail 144e is disposed in the form of a groove, the rail 141a of the dust collector housing 141 may be disposed in the form of a rib or a protruding step.

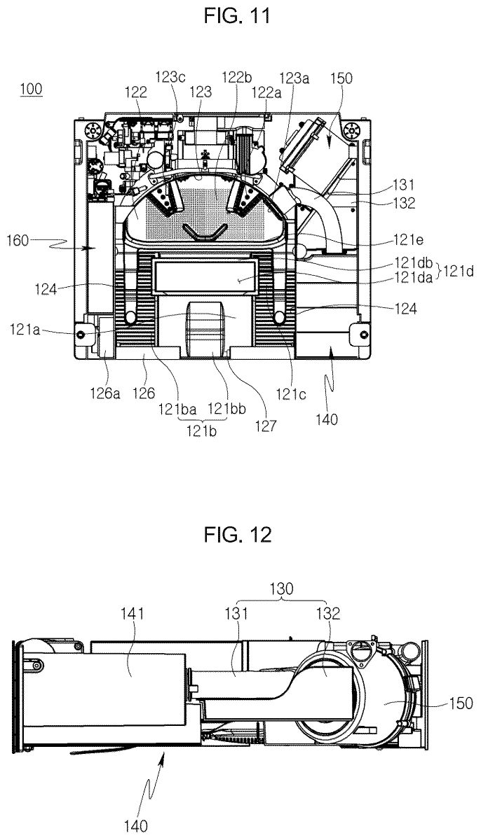

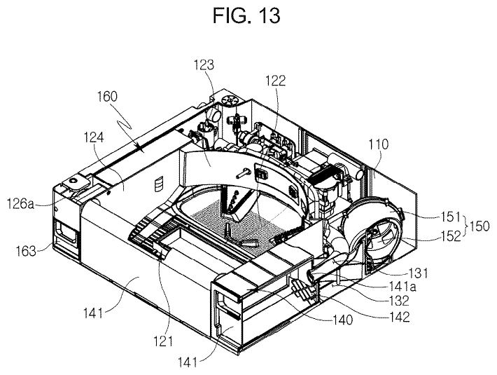

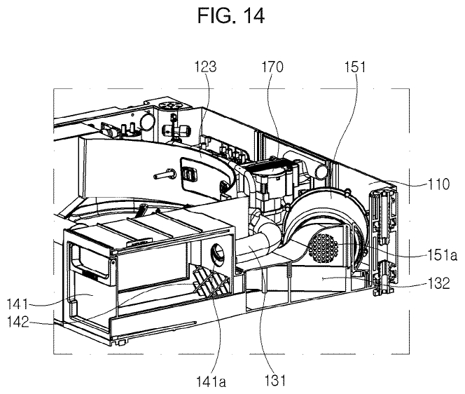

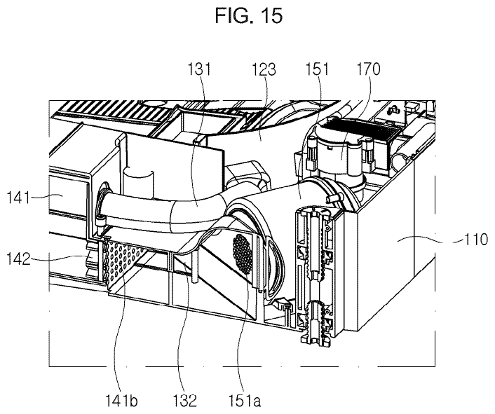

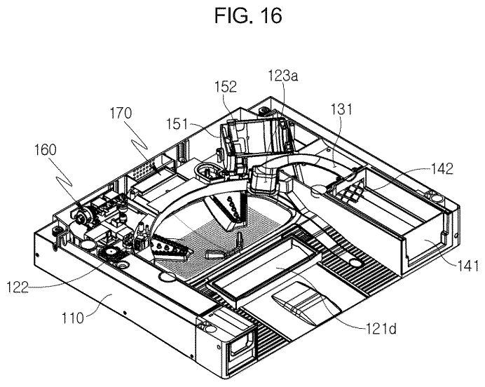

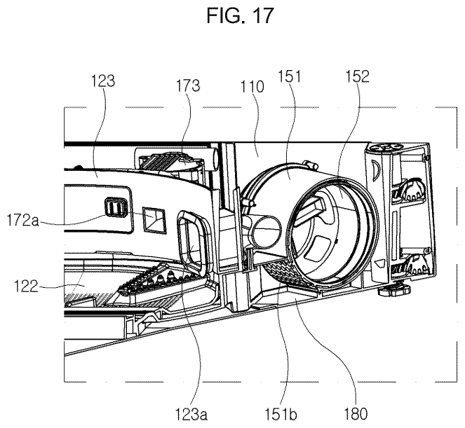

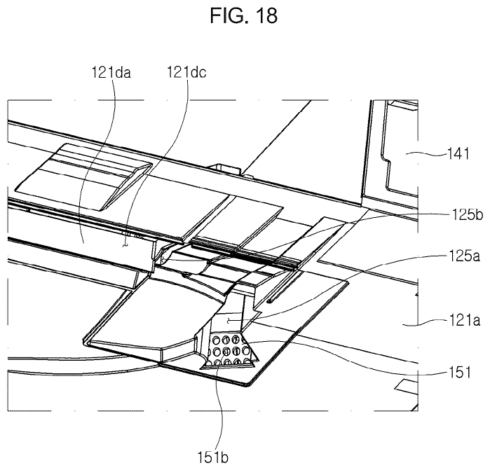

FIG. 12 is a side view for describing a dust collection flow path of the robot cleaner station according to the embodiment of the present disclosure, FIGS. 13 to 16 are cross-sectional views for describing the dust collection flow path of the robot cleaner station according to the embodiment of the present disclosure, and FIG. 17 is a cross-sectional view showing a discharge hole of a dust collection motor housing of the robot cleaner station according to the embodiment of the present disclosure.

A dust collection flow path 130 will be described with reference to FIGS. 12 to 17 as follows.

The robot cleaner station 100 may include the dust collection flow path 130. The dust collection flow path 130 may be a flow path through which the air suctioned through the dust through hole 123a flows to the dust collection motor 152 through the dust collector 140.

Specifically, the dust collection flow path 130 may include the first flow path 131 that allows the dust bin 220 to communicate with the dust collector 140 and the second flow path 132 that allows the dust collector 140 to communicate with the dust collection motor 152 when the robot cleaner 200 is coupled to the robot cleaner station 100 to allow the dust through hole 123a to communicate with the dust bin 220 of the robot cleaner 200.

Meanwhile, according to an embodiment of the present disclosure, the first flow path 131 may be referred to as the suction flow path 131. Hereinafter, for convenience of description, both the first flow path 131 and the suction flow path 131 are referred to as the first flow path 131.

The first flow path 131 may connect the dust bin 220 of the robot cleaner 200 to the dust collector 140. The first flow path 131 may allow the dust bin 220 of the robot cleaner 200 to communicate with the dust collector 140. The first flow path 131 may connect the dust through hole 123a of the seating assembly 120 to the dust collector 140. Further, the first flow path 131 may be a space between the dust bin 220 of the robot cleaner 200 and the dust collector 140. The first flow path 131 may be formed close to a horizontal direction. The first flow path 131 may be a space formed rearward from the dust through hole 123a and may be a flow path formed to be bent from the dust through hole 123a toward the side surfaces to allow dust and air to flow therethrough. The dust in the dust bin 220 of the robot cleaner 200 may move to the dust collector 140 through the first flow path 131.

The second flow path 132 may connect the dust collector 140 to the dust collection motor 152. The second flow path 132 may be formed close to the horizontal direction. In this case, the first flow path 132 and the second flow path 131 may be formed at different heights. The first flow path 131 and the second flow path 132 may be disposed to stack on each other. For example, the second flow path 132 may be disposed to be lower than the first flow path 131. With this configuration, it is possible to minimize the width in the left-right direction and the overall volume of the robot cleaner station 100. However, according to another embodiment of the present disclosure, the second flow path 132 may be disposed to be higher than the first flow path 131.

The dust collection module 150 may provide a suction airflow to the dust collection flow path 130. Specifically, the dust collection module 150 may include a dust collection motor housing 151 and the dust collection motor 152.

The dust collection motor housing 151 may be disposed inside the housing 110. The dust collection motor housing 151 may accommodate the dust collection motor 152 therein.

An introduction hole 151a and a discharge hole 151b may be disposed in the dust collection motor housing 151.

An internal space of the dust collection motor housing 151 may communicate with the second flow path 132 through the introduction hole 151a. Therefore, the introduction hole 151a may guide the air flowing through the second flow path 132 to the dust collection motor 152.

The internal space of the dust collection motor housing 151 may communicate with the circulation flow path 125a through the discharge hole 151b. Therefore, the discharge hole 151b may guide the air passing through the dust collection motor 152 to the circulation flow path 125a.

The dust collection motor 152 may generate a suction force in the dust collection flow path 130. The dust collection motor 152 may be disposed inside the dust collection motor housing 151.

The dust collection motor 152 may be disposed at the rear of the dust collector 140. Therefore, the dust collection motor 152 may provide a suction force capable of suctioning the dust in the dust bin 220 of the robot cleaner 200.

The dust collection motor 152 may generate the suction force by rotation. As an example, the dust collection motor 152 may be disposed in a shape similar to a cylinder, however, the present disclosure is not limited thereto.

The dust collection motor 152 may have one side connected to the second flow path 132 and the other side connected to the circulation flow path 125a. When the dust collection motor 152 is driven, air flowing through the second flow path 132 may flow into the dust collection motor housing 151 through the introduction hole 151a. In addition, the air flowing into the dust collection motor housing 151 may be discharged through the discharge hole 151b after passing through the dust collection motor 152. Further, the air discharged through the discharge hole 151b may flow through the circulation flow path 125a and may be exhausted through the exhaust port 125b.

Meanwhile, a rotational shaft of the dust collection motor 152 may be disposed close to the horizontal direction. In addition, the introduction hole 151a and the discharge hole 151b of the dust collection motor housing 151 may also be open in the horizontal direction. Further, the discharge hole 151b may be located at the same height as the exhaust port 125b. With this configuration, it is possible to minimize the overall volume of the robot cleaner station 100 disposed in the kitchen furniture 2 or the mounting space 21a of the structure.

The exhaust unit 125 may guide the air discharged from the dust collection motor 152 to the outside of the housing 110. The exhaust unit 125 may allow the internal space to communicate with an external space of the housing 110.

The exhaust unit 125 may include the circulation flow path 125a and the exhaust port 125b.

The circulation flow path 125a may provide a flow path through which the air discharged from the dust collection motor 152 flows. The circulation flow path 125a may be disposed inside the bottom member body 121a. The circulation flow path 125a may be connected to the dust collection motor 152 to create a flow path. The circulation flow path 125a may be a flow path connecting the discharge hole 151b to the exhaust port 125b. One end of the circulation flow path 125a may communicate with the internal space of the dust collection motor housing 151, and the other end of the circulation flow path 125a may communicate with the accommodation space 121dc of the recess 121da. Specifically, one end of the circulation flow path 125a may be connected to the discharge hole 151b, and the other end of the circulation flow path 125a may be connected to the exhaust port 125b.

The circulation flow path 125a may be a flow path formed in the horizontal direction inside the housing 110. The circulation flow path 125a may be connected to the dust collection motor 152 in to create a flow path. Specifically, one end portion of the circulation flow path 125a may communicate with the dust collector 140, and the other end portion of the circulation flow path 125a may communicate with the exhaust port 125b.

The exhaust port 125b may function as an outlet that guides the air discharged from the dust collection motor 152 to the accommodation space 121dc of the recess 121da. Therefore, the air discharged from the dust collection motor 152 and flowing through the circulation flow path 125a may be discharged to the outside of the housing 110 through the exhaust port 125b.

The exhaust port 125b may be formed on the bottom member 121. The exhaust port 125b may be formed in the agitator accommodation portion 121d. Further, the exhaust port 125b may be disposed in the recess 121da of the agitator accommodation portion 121d. Additionally, the exhaust port 125b may be disposed on side surfaces of the recess 121da.

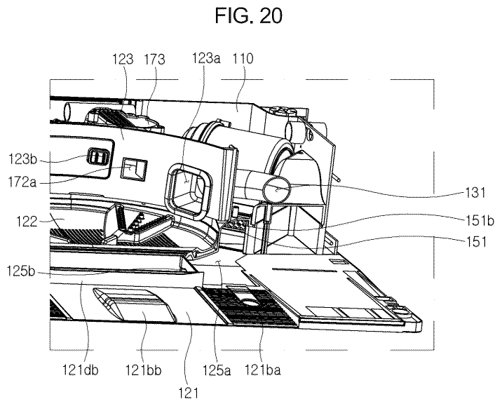

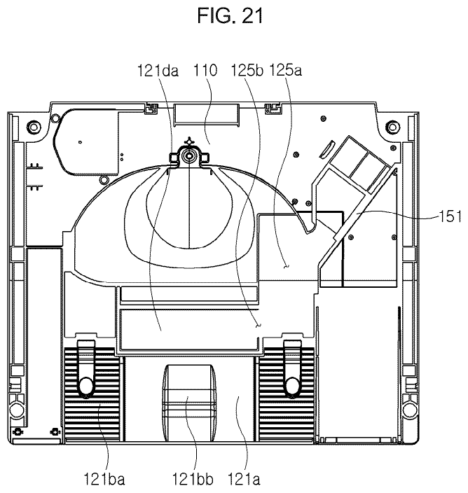

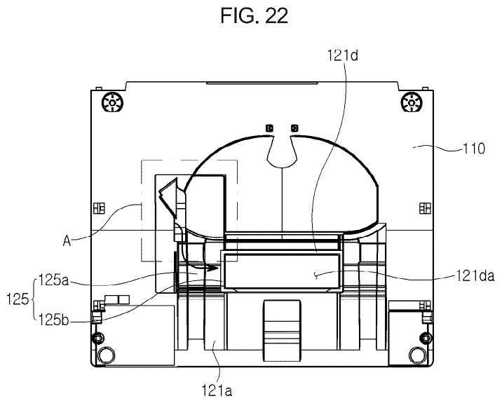

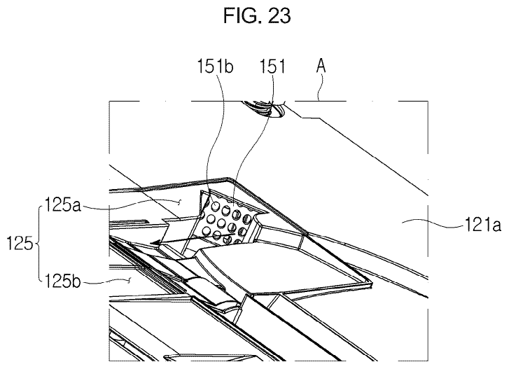

FIGS. 18 to 20 are views for describing the circulation flow path of the robot cleaner station according to the embodiment of the present disclosure, FIGS. 21 and 22 are views showing a state in which a portion of the bottom surface of the bottom member body has been removed to describe the circulation flow path of the robot cleaner station according to the embodiment of the present disclosure, and FIG. 23 is a perspective view for specifically describing area A shown in FIG. 22.

The circulation flow path of the robot cleaner station according to the embodiment of the present disclosure will be described with reference to FIGS. 18 to 23 as follows.

The circulation flow path 125a according to the embodiment of the present disclosure may guide the air discharged from the dust collection motor 152 to the suction unit 211 of the robot cleaner 200.

The circulation flow path 125a may form a structure in which air continuously flows between the robot cleaner 200 and the robot cleaner station 100 by guiding the air discharged from the dust collection motor 152 to the suction unit 211 of the robot cleaner 200 without being discharged to the outside. Therefore, since hot air discharged from the dust collection motor 152 re-flows into the robot cleaner 200 without being discharged to the mounting space 24 of the kitchen furniture 2 to form a circulation flow path, it is possible to prevent damage to the inside of the cabinet including plumbing 2.

The circulation flow path 125a may be a space between the exhaust port 125b of the robot cleaner station 100 and the suction unit 211 of the robot cleaner 200. The circulation flow path 125a may be the recess 121da of the agitator accommodation portion 121d. Additionally, the circulation flow path 125a may be a connection pipe that communicates with the suction unit 211 of the robot cleaner 200 and has the other end communicating with the exhaust port 125b of the robot cleaner station 100.

The air passing through the dust collection motor 152 may be discharged to the accommodation space S through the exhaust port 125b, and the air discharged to the accommodation space S may re-flow into the suction unit 211 due to the suction force of the dust collection motor 152. Therefore, the air suctioned from the dust bin 220 by the suction force of the dust collection motor 152 may be discharged to the accommodation space S after sequentially flowing through the dust through hole 123a, the first flow path 131, the dust collector 140, the second flow path 132, the dust collection motor 152, the circulation flow path 125a, and the exhaust port 125b.

When the dust collection motor 152 is driven in a state in which the dust bin 220 of the robot cleaner 200 communicates with the suction unit 211 of the robot cleaner station 100, air may be suctioned through the suction unit 211 of the robot cleaner 200. In addition, since the agitator 250 is accommodated inside the suction unit 211, the air discharged from the dust collection motor 152 and exhausted through the exhaust port 125b may be suctioned to the suction unit 211 of the robot cleaner 200 by the suction force of the dust collection motor 152.

In this case, the dust collection motor 152 may be driven together when the suction motor of the robot cleaner 200 is driven. Since the air exhausted through the exhaust port 125b is suctioned into the suction unit 211 by the suction force of a suction motor in addition to the dust collection motor 152, it is possible to increase dust collection efficiency.

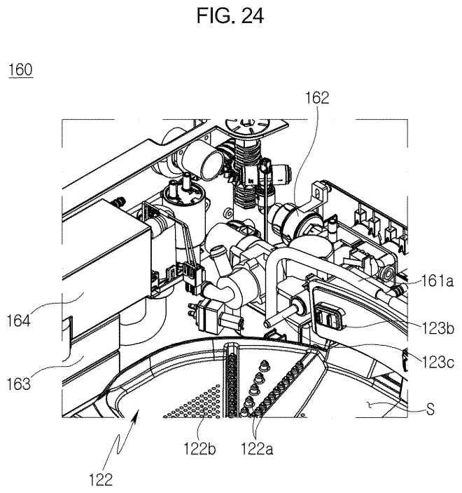

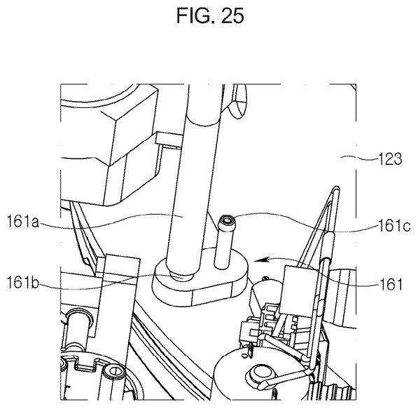

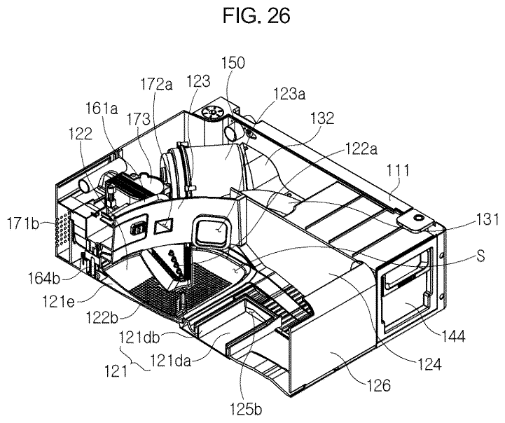

FIG. 24 is an enlarged view for describing a duster washer of the robot cleaner station according to the embodiment of the present disclosure, FIG. 25 is an enlarged view for describing a washing water discharge unit of the duster washer of the robot cleaner station according to the embodiment of the present disclosure, and FIG. 26 is a cross-sectional perspective view for describing a space formed between a washing member and a washing member coupling unit of the robot cleaner station according to the embodiment of the present disclosure. Further, the duster washer 160 may also be known as a duster washing unit.

The duster washer 160 of the robot cleaner station 100 according to the embodiment of the present disclosure will be described with reference to FIGS. 24 to 26 as follows.

The robot cleaner station 100 according to the embodiment of the present disclosure may include the duster washer 160. The duster washer 160 may wash the duster 242 of the robot cleaner 200 coupled to the seating assembly 120.

The duster washer 160 may include a washing water discharge unit 161 for discharging washing water to the washing member 122, the detergent container 163 in which a liquid containing detergent is stored, and the wastewater container 164 in which water used to wash the duster 242 is stored.

In the washing water discharge unit 161, purified water and detergent are mixed to generate washing water for washing the duster 242.

A pair of washing water discharge units 161 may be disposed to be spaced apart from each other at the rear side of the coupling wall 123. The washing water discharge unit 161 may discharge washing water from both upper ends of the washing member 122 toward the washing member 122. In this case, the purified water supplied from the water supply pipe of the kitchen furniture 2 which passes through a regulator 162 may be branched to both sides through a branch flow path 161a and connected to each of the washing water discharge units 161 disposed to be spaced apart from each other. That is, the branch flow path 161a may be disposed in the form of one pipe branched into two, and in this case, an end portion of any one branched may be connected to any one of the pair of washing water discharge units 161, and an end portion of the other branched may be connected to the other of the pair of washing water discharge units 161.

The washing water discharge unit 161 may be disposed integrally with the coupling wall 123 at the rear side of the coupling wall 123 or separably coupled to the coupling wall 123.

A purified water inlet 161b, a detergent inlet 161c, and a washing water outlet may be disposed on the washing water discharge unit 161.

The purified water inlet 161b is a component for guiding purified water supplied from the water supply pipe of the cabinet including plumbing 2 to the washing water discharge unit 161. Specifically, the water supply pipe of the cabinet including plumbing 2 may be connected to the regulator 162 to adjust a flow rate supplied from the water supply pipe. In addition, some of the purified water passing through the regulator 162 may be supplied to the water container 230 of the robot cleaner 200 through the water supply nozzle 123c, and the remainder may flow into the pair of washing water discharge units 161 disposed to be spaced apart from each other through the purified water inlet 161b.

The detergent inlet 161c is a component for guiding a liquid including detergent supplied from the detergent container 163 to the washing water discharge unit 161. Specifically, the liquid including the detergent stored in the detergent container 163 may be supplied to the washing water discharge unit 161 through a pump. However, in another embodiment of the present disclosure, other types of detergent (i.e. a powder detergent) may be used.

In addition, the detergent and purified water flowing into the washing water discharge unit 161 may be used as washing water by being mixed. The washing water discharge unit 161 may discharge the washing water to the upper surface of the washing member 122 through the washing water outlet. The washing water outlet may be formed on a lower surface of the washing water discharge unit 161. The washing water outlet may be open in a direction facing an upper surface of the duster 242 seated on the washing member 122.

The detergent container 163 may store a liquid including detergent. The detergent container 163 includes a detergent container body 163a, a handle 163b, and a detergent container rail 163c.

The detergent container body 163a may provide a space in which a liquid including detergent may be stored. For example, the detergent container body 163a may be formed in the form of a box with an open top, and the rear thereof may be connected to the washing water discharge unit 161.

The handle 163b may be provided at the front of the detergent container body 163a. The handle 163b may be provided so that a user may grip the same. For example, the handle 163b may include a pair of coupling portions hinge-coupled to a front surface of the detergent container body 163a and a grip portion formed to be gripped by the user by connecting the pair of coupling portions.

With this configuration, when the user grips the grip portion and pulls the same forward, the detergent container body 163a may be drawn out by being pulled forward together. Therefore, according to an embodiment of the present disclosure, the user may easily pull the detergent container 163 forward, and then new detergent may be supplied into the detergent container 163.

The detergent container rail 163c may be disposed on side surfaces of the detergent container body 163a in the left-right direction. The detergent container rail 163c may guide the movement of the detergent container body 163a.

For example, the detergent container rail 163c may be disposed in the form of a groove or a rib in the front-rear direction on the side surfaces of the detergent container body 163a in the left-right direction.

With this configuration, when the user couples the detergent container 163 to the housing 110, the detergent container 163 may be connected to a correct location and the washing water can be prevented from leaking out.

Meanwhile, a rail may be disposed in the housing 110 to correspond to the detergent container rail 163c. The rail may be disposed to correspond to the shape and location of the detergent container rail 163c.

The wastewater container 164 may provide a space in which the washing water used to wash the duster 242 is stored. After the washing of the duster 242 is finished, the washing water discharged to the upper surface of the washing member 122 may be drained into the drain hole 122b while moving downward along the inclination of the washing member 122. The washing water passing through the drain hole 122b accumulates between the washing member coupling portion 121e and the washing member 122. In addition, the washing water accumulating between the washing member coupling portion 121e and the washing member 122 may flow into the wastewater container 164 through the pump flow path 164b.

The washing water stored in the wastewater container 164 may be drained into the drain pipe 25 of the cabinet including plumbing 2 through the drain flow path 164a. The drain flow path 164a has one end connected to the wastewater container 164 and the other end connected to the drain pipe 25. In this case, the washing water stored in the wastewater container 164 may flow through the drain flow path 164a by a centrifugal pump and may be drained into the drain pipe 25.

The drain flow path 164a connected to the wastewater container 164 may be connected to the upstream side 25b based on the U-trap 25a of the drain pipe 25 of the cabinet including plumbing 2. This is because, when the drain flow path 164a is connected to the downstream side 25c based on the U-trap 25a of the drain pipe 25, odor or fluid inside the drain pipe 25 may flow back into the drain flow path 164a.

In addition, the duster washer 160 may include a check valve. The check valve can prevent the fluid inside the drain pipe 25 from flowing back into the drain flow path 164a. The check valve may be provided at the other end of the drain flow path 164a connected to the drain pipe 25.

Meanwhile, the detergent container 163 and the wastewater container 164 may be accommodated in a space formed between the side wall 124 and the housing outer wall surface 111. The detergent container 163 may be disposed at a lower side of the space between the side wall 124 and the outer wall surface 111 of the housing, and the wastewater container 164 may be disposed at an upper side of the space between the side wall 124 and the outer wall surface 111 of the housing.

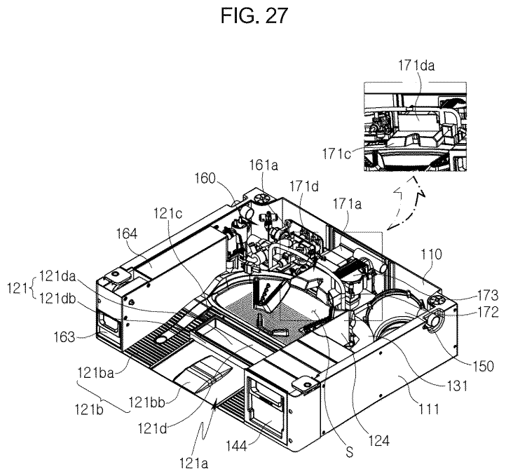

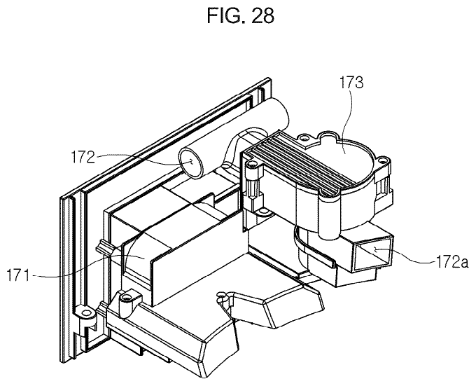

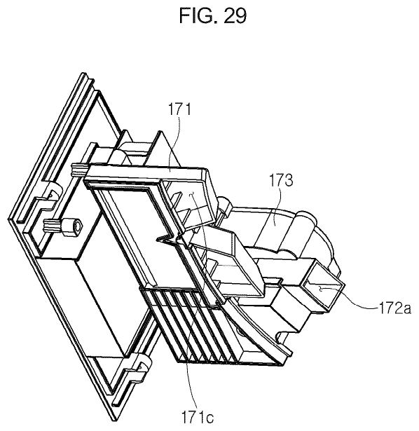

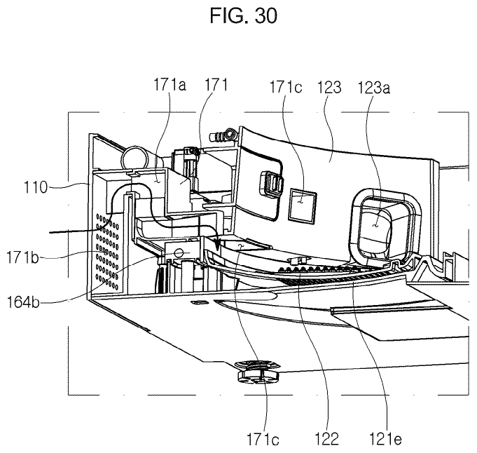

FIG. 27 is a perspective view for describing a duster dryer of a robot cleaner station according to a first embodiment of the present disclosure, FIGS. 28 and 29 are enlarged views of a duster dryer of the robot cleaner station according to the first embodiment of the present disclosure, and FIG. 30 is a cross-sectional view for describing a state in which air flows inside a hot air supply module according to the first embodiment of the present disclosure. Further, the duster dryer 170 may also be known as a duster drying unit.

Referring to FIGS. 27 to 30, the robot cleaner station 100 according to the first embodiment of the present disclosure may include the duster dryer 170. In this case, the duster dryer 170 may dry the duster 242 of the robot cleaner 200 washed by the duster washer 160 or the duster 242 that is in a wet state after the water washing operation has been finished.

The duster dryer 170 according to the first embodiment of the present disclosure may include a hot air supply module 171, a steam discharge flow path 172, an exhaust fan 173, and a check valve.

The hot air supply module 171 may supply hot air to the accommodation space S and include a connection flow path 171a, a blowing fan, and a heater 171d.

The connection flow path 171a may connect the external space of the housing 110 to the accommodation space S. An air inlet 171b of the connection flow path 171a may communicate with the external space, and an air outlet 171c of the connection flow path 171a may communicate with the accommodation space S.

The air inlet 171b of the connection flow path 171a may be disposed on the rear surface of the housing 110. The air outlet 171c of the connection flow path 171a may be disposed at the upper side of the washing member 122. The air outlet 171c may be open in a direction facing the washing member 122. A pair of air outlets 171c may be provided in a downward open state.

The air outlet 171c may be opened toward the upper surface of the duster 242 in a state in which the duster 242 is seated on the washing member 122. The air outlet 171c may be located adjacent to the duster 242 in a state in which the duster 242 is seated on the washing member 122 and may be opened downward so that the discharged air may flow toward the duster 242. The air outlet 171c may be opened in a direction facing the duster 242 in a state in which the robot cleaner 200 is coupled to the seating assembly 120.

The blowing fan may be disposed on the connection flow path 171a and may blow air toward the accommodation space S. When the blowing fan is driven, the air introduced through the air inlet 171b may be heated by the heater 171d and discharged into the accommodation space S through the air outlet 171c.

The heater 171d may be disposed on the connection flow path 171a and may heat the air flowing through the connection flow path 171a. The heater 171d may heat the air discharged through the air outlet 171c. The heater 171d may be disposed on the connection flow path 171a but alternatively, may be disposed at the air outlet 171c. That is, as long as the air discharged into the accommodation space S may be heated, there are no restrictions to a specific form, location, or arrangement of the heater 171d.

The heater 171d may include a heater housing 171da and a heating element. The heater housing 110 may be disposed on the connection flow path 171a, and a space in which the heater 171d may be accommodated may be provided therein. The heating element may heat external air flowing into the heater housing 110. Therefore, the air heated by the heating element may be discharged into the accommodation space S through the air outlet 171c to dry the wet duster 242.

The steam discharge flow path 172 may discharge hot and humid air in the accommodation space S, which has been generated while drying the duster 242, to the drain pipe 25. The steam discharge flow path 172 may connect the accommodation space S to the drain pipe 25 of the kitchen furniture 2.

The steam discharge flow path 172 may have one end connected to the accommodation space S and the other end connected to the drain pipe 25. Specifically, the air inlet 172a that is one end of the steam discharge flow path 172 may be connected to the accommodation space S, and the air outlet that is at the other end may be connected to the drain pipe 25.

The steam discharge flow path 172 may be connected downstream side 25c based on the U-trap 25a of the drain pipe 25 of the cabinet including plumbing 2. This is because, when the steam discharge flow path 172 is connected to the upstream side 25b based on the U-trap 25a of the drain pipe 25, the heat exhausted through the steam discharge flow path 172 due to the water accumulating in the U-trap 25a may not pass through the drain pipe 25.

Meanwhile, the steam discharge flow path 172 may have one pipe branched into two pipes inside the housing 110, thereby passing through both sides of the housing 110. In this case, any one branched may pass through a left outer wall surface of the housing 110, and the other branched may pass through a right outer wall surface of the housing 110. The steam discharge flow path 172 passing through the outer wall surfaces 111 of both sides of the housing 110 may be connected to the drain pipe 25. Therefore, steam in the accommodation space S suctioned from the steam discharge flow path 172 may flow through the steam discharge flow path 172 branched on both sides and may be exhausted to the downstream side 25c based on the U-trap 25a of the drain pipe 25.

The exhaust fan 173 may exhaust the air in the accommodation space S to the drain pipe 25 through the steam discharge flow path 172. The exhaust fan 173 may cause a flow of air along the steam discharge flow path 172. The exhaust fan 173 may be disposed on the steam discharge flow path 172.

When the exhaust fan 173 is driven, air in the accommodation space S may flow into the air inlet 172a. The air flowing into the air inlet 172a may flow through the steam discharge flow path 172 and may be drained to the drain pipe 25. Specifically, the air flowing through the steam discharge flow path 172 by the driving of the exhaust fan 173 may be exhausted to the downstream side 25c based on the U-trap 25a of the drain pipe 25.

The duster dryer 170 may include the check valve. The check valve can prevent a fluid inside the drain pipe 25 from flowing back into the steam discharge flow path 172. The check valve may be provided at the other end of the steam discharge flow path 172 connected to the drain pipe 25.

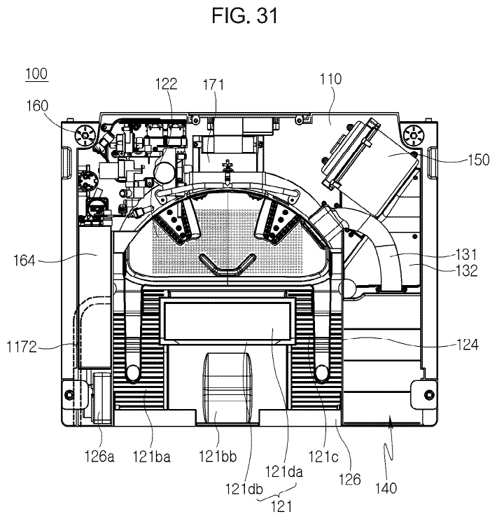

FIG. 31 is a view for describing a duster dryer of a robot cleaner station according to a second embodiment of the present disclosure.

The duster dryer 170 according to the second embodiment of the present disclosure may include a hot air supply module, a steam discharge flow path, an exhaust fan, and a check valve.

To avoid overlapping description, the contents of the duster dryer 170 according to the first embodiment of the present disclosure may be used for other configurations, except for those specifically stated in the second embodiment of the present disclosure.

The steam discharge flow path of the duster dryer according to the second embodiment of the present disclosure may discharge hot and humid air in the accommodation space S generated while drying the duster 242 to the outside of the housing 110.

The steam discharge flow path of the duster dryer according to the second embodiment of the present disclosure may be disposed in a space formed between the side wall 124 and the outer wall surface 111 of the housing 110. Specifically, in the second embodiment of the present disclosure, the steam discharge flow path may be disposed at the upper side of the wastewater container 164, between the wastewater container 164 and the detergent container 163, or at the lower side of the detergent container 163. In the second embodiment of the present disclosure, the air inlet of the steam discharge flow path may be disposed on the side wall 124, and the air outlet of the steam discharge flow path may be disposed on the front surface of the housing 110. In the second embodiment of the present disclosure, the air outlet may be disposed at the upper side of the wastewater container 164, between the wastewater container 164 and the detergent container 163, or at the lower side of the detergent container 163. Therefore, in the second embodiment of the present disclosure, one end of the steam discharge flow path may communicate with the accommodation space S, and the other end may communicate with the external space of the housing 110.

The exhaust fan of the duster dryer according to the second embodiment of the present disclosure may discharge the air in the accommodation space S to the external space of the housing 110 through the steam discharge flow path. In addition, in the second embodiment of the present disclosure, the duster 242 of the robot cleaner 200 may be disposed between the hot air supply module and the exhaust fan. That is, since the hot air supply module is disposed in a rear space of the coupling wall 123 and the exhaust fan is disposed on the side wall 124, the duster of the robot cleaner 200 may be disposed on a straight line connecting the hot air supply module to the exhaust fan.

Meanwhile, in the second embodiment of the present disclosure, a guide member for guiding air in a direction away from the outer wall surface 111 of the housing 110 may be disposed at the outlet of the steam discharge flow path. The direction away from the outer wall surface 111 of the housing 110 may be a direction toward the center of the front surface of the housing 110. For example, the guide member may guide the hot air discharged through the outlet of the steam discharge flow path in a direction toward the bottom member 121.

When the robot cleaner station 100 according to an embodiment of the present disclosure is disposed in the mounting space of the cabinet including plumbing 2, the outer wall surface 111 of the housing 110 may be in contact with the baseboard 26 of the cabinet including plumbing 2. In this case, since the baseboard 26 has characteristics of being vulnerable to moisture, the baseboard 26 may be damaged when the hot air discharged from the steam discharge flow path flows toward the outer wall surface of the housing 110. Therefore, when the guide member for guiding the hot air discharged in the direction away from the outer wall surface 111 of the housing 110 is installed at the outlet of the steam discharge flow path according to the second embodiment of the present disclosure, it is possible to prevent damage to the baseboard 26.

In the second embodiment of the present disclosure, the guide member may be a vane or louver for guiding the hot air discharged through the outlet of the steam discharge flow path in one direction. The guide member may guide the hot air discharged to the outlet of the steam discharge flow path inward from the housing 110. The hot air discharged to the outside of the housing 110 through the outlet of the steam discharge flow path may flow in a direction away from the inner wall surface of the cabinet including plumbing 2 by the guide member.

The hot air discharged to the outside of the housing 110 through the outlet of the steam discharge flow path may flow in the direction away from the outer wall surface of the housing 110 by the guide member. For example, the hot air discharged to the outside of the housing 110 through the outlet of the steam discharge flow path may flow in a direction toward the bottom member 121.

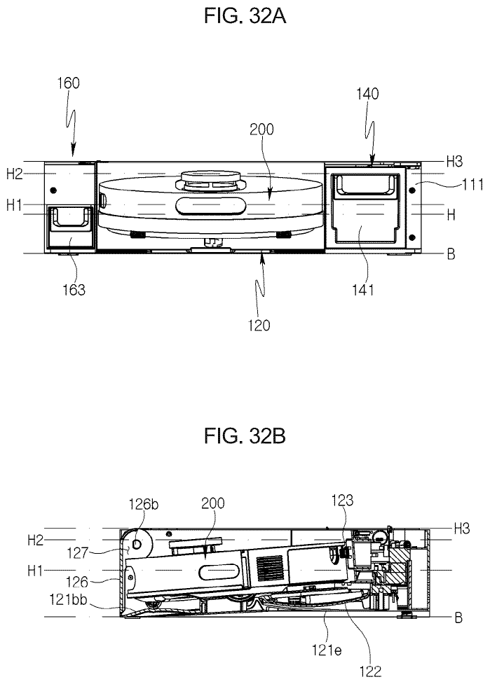

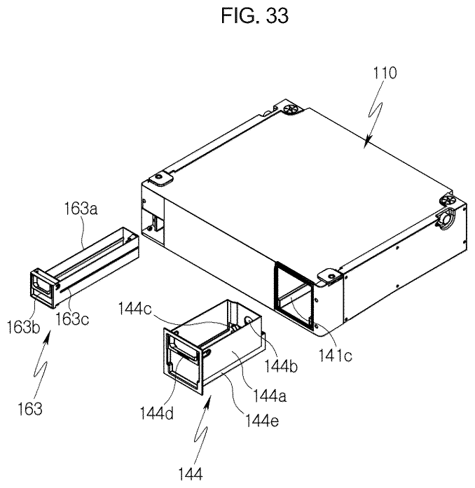

FIG. 32A is a front view for describing the arrangement relationship on a horizontal plane of the robot cleaner station according to the embodiment of the present disclosure, FIG. 32B is a side view of FIG. 32A, and FIG. 33 is a view showing a state in which a dust collector and a detergent container are drawn out from the robot cleaner station according to the embodiment of the present disclosure.

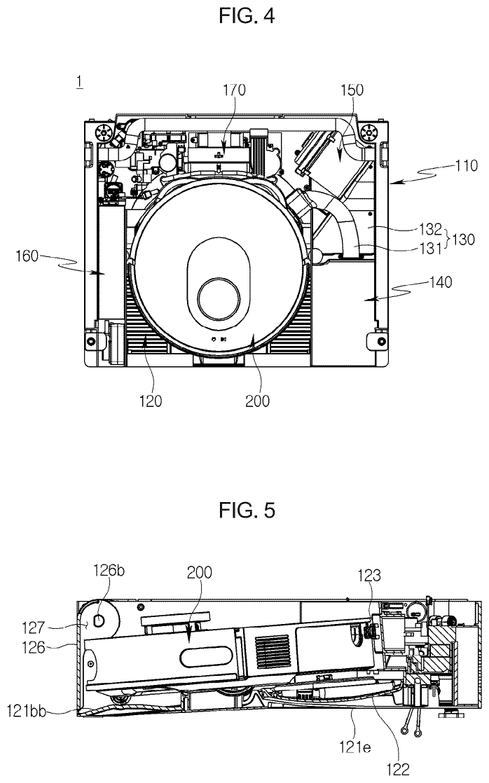

The arrangement of the robot cleaner station 100 according to the embodiment of the present disclosure will be described with reference to FIGS. 4, 32A, 32B, and 33 as follows.

The robot cleaner station 100 according to the embodiment of the present disclosure is disposed in the lower space of the kitchen furniture 2.

To this end, the robot cleaner station 100 according to the embodiment of the present disclosure is disposed in the horizontal direction according to a space formed between the bottom plate 23 of the kitchen furniture 2 and the floor of the kitchen.

Specifically, the robot cleaner station 100 according to the embodiment of the present disclosure may have the dust collector 140 and/or the duster washer 160 that are disposed on side surfaces of the entrance 127.

In this case, when both the dust collector 140 and the duster washer 160 are provided, the seating assembly 120 may be disposed between the dust collector 140 and the duster washer 160.

For example, the entrance 127 and the door 126 may be disposed at the front of the robot cleaner station 100. In addition, the seating assembly 120 to which the robot cleaner 200 is coupled may be disposed rearward from the entrance 127. In this case, the dust collector 140 may be disposed rearward by a predetermined length from a front end of the robot cleaner station 100. In addition, the duster washer 160 may also be disposed rearward by a predetermined length from the front end of the robot cleaner station 100.

Therefore, when viewing the robot cleaner station 100 from a front outside of the robot cleaner station 100, a front end of the dust collector 140 and/or a front end of the duster washer 160 may be disposed at the left and right sides of the entrance 127.

In this case, the dust bag of the dust collector 140 may be provided to be drawn out from the housing 110. In addition, the detergent container 163 of the duster washer 160 may be provided to be drawn out from the housing.

That is, the front end of the dust collector 140 may be provided with the handle 144d that allows the user to grip the dust collector housing 141. In addition, the handle 163b may be provided at the front end of the duster washer 160 to pull the detergent container 163.

With this configuration, when the user intends to draw the dust bag or the detergent container 163 out, the user may immediately recognize the drawn-out location, and the convenience capable of drawing the dust bag or the detergent container 163 out with a simple action of pulling the handle can be provided.

Meanwhile, rear ends of the dust collector 140 and the duster washer 160 may be disposed to be spaced a predetermined distance from the rear end of the housing 110. In addition, the dust collection motor 152 may be disposed between the rear end of the housing 110 and the rear end of the dust collector 140. With this configuration, an electric wire through which power is supplied to the dust collection motor 152 may be easily connected. In addition, it is possible to minimize the total space of the seating assembly 120, the dust collector 140, and the dust collection motor 152 in a limited space.

In addition, at least portions of a flow path through which washing water for washing the duster 242 may flow and a pump for providing a flow force of the washing water may be disposed between the rear end of the housing 110 and the rear end of the duster washer 160. With this configuration, it is possible to minimize the path through which washing water flows from the water supply pipe. In addition, it is possible to minimize the total space of the seating assembly 120, the duster washer 160, and the flow path through which the washing water flows in the limited space.

Meanwhile, the robot cleaner station 100 may have the duster dryer 170 disposed behind the seating assembly 120. In this case, the duster dryer 170 may be disposed between a rear end of the seating assembly 120 and the rear end of the housing 110.

Therefore, in the robot cleaner station 100 according to the embodiment of the present disclosure, the dust collector 140 and the duster washer 160 may be disposed on the left and right side surfaces with respect to the seating assembly 120, and the duster dryer 170 may be disposed at the rear side of the robot cleaner station 100.

That is, in the robot cleaner station 100 according to the embodiment of the present disclosure, the dust collector 140, the duster washer 160, and the duster dryer 170 may all be disposed within a predetermined distance range from an outer edge of the seating assembly 120.

With this arrangement, the seating assembly 120, the dust collector 140, the duster washer 160, and the duster dryer 170 may all be disposed in the narrowest space on a horizontal plane. Accordingly, a vertical height for the robot cleaner station 100 can be minimized.

Since this shortens a distance between the dust bin 220 of the robot cleaner 200 and the dust collector 140, it is possible to minimize flow path loss. In addition, it is possible to restrict a range in which washing water and wastewater finishing washing are present by minimizing a distance between the duster 242 of the robot cleaner 200 and the duster washer 160 and a distance between the duster 242 of the robot cleaner 200 and the duster dryer 170.

In addition, with this arrangement, the components of the robot cleaner station 100 according to an embodiment of the present disclosure may all be disposed within a limited height.

Specifically, based on a state in which the robot cleaner 200 is coupled to the seating assembly 120, at least a portion of the dust collector 140 may be disposed to be lower than the uppermost end of the robot cleaner 200. In addition, at least a portion of the duster washer 160 may be disposed to be lower than the uppermost end of the robot cleaner 200. Further, at least a portion of the duster dryer 170 may be disposed to be lower than the uppermost end of the robot cleaner 200. Additionally, at least a portion of the duster washer 160 may be disposed to be lower than the uppermost end of the dust collector 140.

In addition, based on a state in which the robot cleaner 200 is coupled to the seating assembly 120, the uppermost end of the robot cleaner 200 may be disposed to be higher than the dust bag. Furthermore, the uppermost end of the robot cleaner 200 may be disposed to be higher than the detergent container 163. Additionally, the uppermost end of the dust bag may be disposed to be higher than the detergent container 163.

From another perspective, when a virtual plane H parallel to the floor of the kitchen is drawn based on the floor of the kitchen in a state in which the robot cleaner 200 is coupled to the seating assembly 120, the plane H may pass through the robot cleaner 200, the dust collector 140, the duster washer 160, and the duster dryer 170. This means that all components may be disposed within a predetermined height range.

From still another perspective, in a state in which the robot cleaner 200 is coupled to the seating assembly 120, the seating assembly 120 may be partitioned into three areas in the vertical direction. In this case, the seating assembly 120 may include a first area (space between B and H1) located on the same horizontal space as the detergent container 163, a second area (space between H1 and H2) disposed above the first area and located on the same horizontal space as at least a portion of the dust bag, and a third area (space between H2 and H3) disposed above the second area. In this case, both the dust bag and the detergent container 163 may be disposed at both sides of the first area in the left-right direction, the dust bag and the wastewater container 164 may be disposed at both sides of the second rear in the left-right direction, and only the upper end of the robot cleaner 200 may be disposed in the third area.

As a result, in the robot cleaner station 100 according to the embodiment of the present disclosure, the dust collector 140, the duster washer 160, and the duster dryer 170 may be disposed on three surfaces surrounding the seating assembly 120, except for the front surface into which the robot cleaner 200 enters. With this arrangement, even in a situation in which the vertical height is limited, the robot cleaner 200 may be charged using the minimum horizontal space, the dust of the robot cleaner 200 may be collected, the duster 242 may be washed, and the duster 242 may be dried.

As described above, according to the robot cleaner station according to an embodiment of the present disclosure, a lower space of the kitchen furniture can be used by arranging the module capable of charging the robot cleaner, collecting dust, and washing the duster in the direction parallel to the robot cleaner.

In addition, the charging terminal, the dust collector, the duster washer, and the duster dryer may be disposed to surround the robot cleaner and simultaneously perform various functions on the robot cleaner.

Further, since other surfaces excluding the front surface are covered by the kitchen furniture, it is possible to provide the user with the aesthetic sense in terms of an interior design.

Additionally, since the dust in the dust bin of the robot cleaner is automatically collected when the robot cleaner is coupled, the user draws only the dust bag out at a regular cycle, and thus it is possible to reduce the user's labor.

In addition, since the duster of the robot cleaner may be automatically washed when the robot cleaner is coupled, it is possible to reduce the inconvenience of separating and separately washing the duster.

Furthermore, since detergent may be added as needed, it is possible to increase the washing effect of the duster.

In addition, since the duster is washed using the water supply pipe and the drain pipe of kitchen, it is possible to reduce the user's inconvenience of injecting water or discharging wastewater separately.

Further, since the duster may be automatically dried by supplying hot air to the duster after the duster of the robot cleaner is washed, it is possible to prevent the occurrence of odor due to the wet duster.

In addition, it is possible to prevent the backflow of the odor by discharging the air after drying to the downstream of the U-trap.

Additionally, since the door of the robot cleaner station is closed when the robot cleaner enters the robot cleaner station, it is possible to prevent dust from scattering to the outside while the dust in the dust bin is collected.

In addition, it is possible to prevent wastewater from leaking to the outside when the duster of the robot cleaner is washed.

Although the present disclosure has been described in detail through specific embodiments, this is intended to specifically describe the present disclosure, and it is apparent that the present disclosure is not limited thereto, and the present disclosure can be modified or improved by those skilled in the art without departing from the technical spirit of the present disclosure.

All simple modifications or changes of the present disclosure fall within the scope of the present disclosure, and the specific scope of the present disclosure will be made clear by the appended claims.

DESCRIPTION OF REFERENCE NUMERALS

| | |
|---|---|
| 1: cleaner system | 2: kitchen furniture |
| 100: robot cleaner station | 110: housing |
| 120: seating assembly | 130: dust collection flow path |
| 140: dust collector | 150: dust collection module |
| 160: duster washer | 170: duster dryer |
| 200: robot cleaner | 210: body |
| 220: dust bin | 230: water container |
| 240: rotational cleaning unit | 250: agitator |
| 260: wheel | 270: auxiliary wheel |
| 280: charging terminal | |

What is claimed is:

1. A robot cleaner station comprising:
a housing located at a lower portion of kitchen furniture;
a seating assembly located in the housing, the seating assembly being configured to accommodate a robot cleaner;
a dust collector configured to empty dust of the robot cleaner; and
a duster washer configured to wash a duster of the robot cleaner.

2. The robot cleaner station of claim 1, wherein the kitchen furniture includes a storage space located above the housing, and
wherein portions of a drain pipe are located in the storage space of the kitchen furniture.

3. The robot cleaner station of claim 1, wherein the dust collector is located at a first side of the seating assembly, and
wherein the duster washer is located at a second side of the seating assembly, the second side of the seating assembly being opposite the first side of the seating assembly.

4. A robot cleaner station comprising:
a housing located at a lower portion of a cabinet including plumbing;
a seating assembly located in the housing, the seating assembly being configured to accommodate a robot cleaner;
an entrance configured to allow entry of the robot cleaner into the housing, the entrance being located at a front surface of the housing, the entrance having an upper surface, a first side surface and a second side surface, the second side surface being opposite to the first side surface; and
a detergent container configured to store a detergent, the detergent container being located at the first side surface of the entrance.

5. The robot cleaner station of claim 4, further comprising a dust bag drawer configured to be coupled to a dust bag that collects dust of the robot cleaner,
wherein the dust bag drawer is located at the second side surface of the entrance.

6. The robot cleaner station of claim 4, further comprising a duster dryer configured to dry a duster of the robot cleaner,
wherein the duster dryer is located behind a coupling unit.

7. The robot cleaner station of claim 4, further comprising a dust bag drawer configured to couple a dust bag that collects dust of the robot cleaner,
wherein the entrance is located between the dust bag drawer and the detergent container.

8. The robot cleaner station of claim 4, wherein, when the robot cleaner is accommodated on the seating assembly, at least a portion of the detergent container is located lower than an uppermost end of the robot cleaner.

9. The robot cleaner station of claim 4, further comprising a dust bag drawer configured to couple a dust bag that collects dust of the robot cleaner,
wherein, when the robot cleaner is accommodated on the seating assembly, at least a portion of the dust bag drawer is located to be lower than an uppermost end of the robot cleaner.

10. The robot cleaner station of claim 4, further comprising a dust bag drawer configured to be coupled to a dust bag that collects dust of the robot cleaner,
wherein the seating assembly is located between the dust bag drawer and the detergent container.

11. The robot cleaner station of claim 4, further comprising a duster dryer configured to dry a duster of the robot cleaner,
wherein, when the robot cleaner is accommodated on the seating assembly, at least a portion of the duster dryer is located lower than an uppermost end of the robot cleaner.

12. The robot cleaner station of claim 4, further comprising a dust bag configured to collect dust of the robot cleaner, the dust bag being located in the housing, the dust bag being configured to be drawn out from the housing.

13. The robot cleaner station of claim 4, wherein the detergent container is located in the housing, the detergent container being configured to be drawn out from the housing.

14. The robot cleaner station of claim 4, further comprising a door located at the front surface of the housing, the door being configured to open and close the entrance.

15. The robot cleaner station of claim 4, wherein the plumbing includes at least one of a sink pipe and a drain pipe.

16. The robot cleaner station of claim 15, wherein the robot cleaner station is connected to the plumbing.

17. A robot cleaner station comprising:
a housing located at a lower portion of a cabinet including plumbing;
an entrance configured to allow entry of the robot cleaner into the housing;
a detergent container configured to store a detergent, the detergent container being located at a first side of the entrance; and
a dust bag drawer configured to couple to a dust bag that collects dust of the robot cleaner, the dust bag drawer being located at a second side of the entrance, the second side of the entrance being opposite to the first side of the entrance.

18. A robot cleaner station comprising:
a housing located at a lower portion of a cabinet including plumbing;
a detergent container configured to store a detergent; and
a seating assembly located in the housing, the seating assembly being configured to accommodate a robot cleaner, the seating assembly including:
a first area located in a same horizontal space as the detergent container; and
a second area located above the first area.

19. The robot cleaner station of claim 18, further comprising a dust bag drawer configured to couple to a dust bag that collects dust of the robot cleaner,
wherein the seating assembly further includes a third area located above the second area, and
wherein the second area is located in a same horizontal space as at least a portion of the dust bag drawer.

20. The robot cleaner station of claim 18, wherein the detergent container and the dust bag are located at opposite sides of the seating assembly.
